(19) United States
(12) Patent Application Publication
(10) Pub. No.: US 2010/0085851 A1
(43) Pub. Date: Apr. 8, 2010

(54) METHOD AND APPARATUS FOR EVALUATING INFORMATION RECORDING MEDIUM

(75) Inventors: Kiyotaka ITO, Osaka (JP); Yasumori HINO, Nara (JP); Harumitsu MIYASHITA, Nara (JP); Isao KOBAYASHI, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/244,231

(22) Filed: Oct. 2, 2008

(51) Int. Cl. G11B 27/36

(52) U.S. Cl. 369/53.1; G9B/27.052

(57) ABSTRACT

The present invention has an object of evaluating a recording and reproduction signal quality of a high density information recording medium by providing an index representing, in a detection signal including a plurality of pieces of edge shift information, how each edge is shifted. A signal evaluation method, usable for an information recording medium having a data sequence including a mark and a space located alternately, for generating a binary signal from a signal obtained by reproducing the data sequence using a PRML signal processing method and evaluating a likelihood of the binary signal, includes a differential metric calculation step of calculating, from the binary signal, a differential metric which is a difference of a reproduction signal from a first state transition matrix having a maximum likelihood and a second state transition matrix having a second maximum likelihood; and a step of classifying the differential metric to any of a plurality of data patterns each including at least one mark and at least one space. The data pattern classification to any of the plurality of data patterns is performed using a combination of a length of a first mark included in the data sequence and a length of a first space adjacently located immediately previous or immediately subsequent to the first mark, and is further performed using a length of a second mark which is not adjacent to the first mark and located adjacent to the first space; and thus a reproduction signal quality of the information recording medium is evaluated.

### BACKGROUND OF THE INVENTION

1. Field of the Invention

The present invention relates to a signal processing method using maximum likelihood decoding and a method for evaluating an information recording medium using maximum likelihood decoding.

2. Description of the Related Art

Recently, as the recording density for information recording mediums is being improved, the shortest mark length of recording marks is approaching the limit of the resolving power, which relies on a detection system.

In the case where, for example, an information recording medium is an optical disc medium, the “resolving power, which relies on a detection system” means an optical resolving power, which relies on the size of an optical spot generated by collecting laser light.

Due to the limit of the resolving power, increase of the inter-code interference and deterioration of SNR (Signal to Noise Ratio) are more conspicuous. As a result, a PRML (Partial Response Maximum Likelihood) method or the like is now used generally as a signal processing method.

The PRML method is a technology generated by combining partial response (PR) and maximum likelihood (ML). By the PRML method, with a premise that known inter-code interference occurs, a signal sequence having the maximum likelihood is selected from a reproduction waveform.

Owing to this, the PRML method is known to improve the decoding capability than a conventional level determination method (e.g., “Illustrated Blu-ray Disc Reader” (“Zukai Blu-ray Disc Dokuhon”)) published by Ohmsha, Ltd.).

In the meantime, because the signal processing method is now changed from the level determination method to the PRML method, problems occur in the evaluation method of a reproduction signal.

Jitter, which is a conventionally used reproduction signal evaluation index, is used with a premise that signal processing is performed by the level determination method. Therefore, occasionally, jitter may not be correlated with the decoding capability of the PRML method, which is based on a different signal processing algorithm from the level determination method.

Under the circumstances, new indices which are correlated with the decoding capability of the PRML method has been proposed (e.g., Japanese Laid-Open Patent Publications Nos. 2003-141823 and 2004-213862).

Now, a case where the recording and reproduction quality is detected as distributions shown in FIG. 15 will be discussed.

FIG. 15 shows four distributions of differential metrics classified by the length of the space of 2T, 3T, 4T or 5T combined with a 3T-long mark, and the total of the four distributions. T represents a channel clock.

In FIG. 15, only 3T-long marks are classified as an example, but usually marks of other lengths are also classified.

In the case where classification is made by the length of the mark and the length of the space, there are the following two cases. In the case of FIG. 15(a), an SN component, which is the distribution width, is dominant in the distributions of in all the mark-space combinations. In the case of FIG. 15(b), an SN component of each pattern is good, but a shift component from the center of the distribution is different among the patterns. When the distributions are summed up, it appears that the SN component is poor.

The index described in Japanese Laid-Open Patent Publication No. 2003-141823 cannot distinguish whether each distribution of differential metric is caused by an SN component or by a shift component.

Japanese Laid-Open Patent Publication No. 2004-335079 solves this problem.

The index proposed in Japanese Laid-Open Patent Publication No. 2004-335079 can detect a positional shift between a mark and a space (edge shift) by a combination of a mark length and a space length.

Namely, the level of the recording and reproduction quality obtained by the index proposed in Japanese Laid-Open Patent Publication No. 2003-141823 can be distinguished as corresponding to an SN component or as corresponding to a shift component.

Owing to such distinguishing between an SN component and a shift component, it is now possible to analyze which type of error occurs in which pattern.

As described above, as the recording density of information recording mediums is more improved, the problems of the inter-code interference and SN deterioration will be more serious.

It is described in “Illustrated Blu-ray Disc Reader” (“Zukai Blu-ray Disc Dokuhon”), Ohmsha, Ltd. that the system margin of an information recording and reproduction apparatus can be maintained by using a higher-order PRML method.

For example, when the recording capacity of one recording layer of a 12-cm optical disc medium is 25 GB, the system margin can be maintained by adopting the PR1221ML method.

The above-mentioned book describes that when the recording capacity of one recording layer is 33.3 GB, the PR12221ML method needs to be adopted.

Japanese Laid-Open Patent Publication No. 2004-335079 proposes an index capable of detecting a positional shift of a combination of one mark and one space (edge shift). The positional shift represents the recording and reproduction quality of an information recording medium.

However, in an information recording medium having a higher recording density, there are marks and spaces which are much shorter than the length detectable by the resolving power of the detection system. Therefore, it is necessary to consider a positional shift including a plurality of edges provided by a combination of one or more marks and one or more spaces.

Hereinafter, a positional shift including a plurality of edges will be described.

The description will be given with a 12-cm optical disc medium for blue laser having a wavelength of 405 nm as an example.

According to “Illustrated Blu-ray Disc Reader”, Ohmsha, Ltd., when blue laser is collected on an optical disc medium, the size of an optical spot is 390 nm. When the recording capacity of one recording layer using RLL(1,7) as a recording code is 25 GB, the length of the shortest mark is 149 nm.

When the recording capacity of one recording layer of this optical disc medium is 33.3 GB, the length of the shortest mark is 112 nm. When the recording density is further improved, the length of the shortest mark is shorter.

Even where an identical detection system is used, when the recording density is 25 GB as shown in FIG. 16(a), the number of the shortest marks encompassed in an optical spot 201 is 2.6; whereas when the recording density is 33.3 GB as shown in FIG. 16(b), the number of the shortest marks encompassed in the optical spot 201 is 3.5. The length of the marks in the size of optical spot, which acts as the detection system for the optical disc medium, is shorter.

Therefore, an optical spot size may occasionally encompass a combination of a plurality of marks and spaces, instead of a combination of one mark and one space.

As a result, a signal influenced by a positional shift of a plurality of edges is detected, depending on the number of the marks and spaces encompassed in the optical spot size.

For example, a pattern in FIG. 17(a) in which one mark is sandwiched by two spaces, and a pattern in FIG. 17(b) in which one space is sandwiched by two marks, both include two edges. A pattern in FIG. 17(c), which include two marks and two spaces, includes three edges.

The index for evaluating the recording and reproduction quality of an information recording medium described in Japanese Laid-Open Patent Publication No. 2004-335079 considers only the case where one edge shift of a combination of a mark length and a space length is included, and does not consider evaluating the recording and reproduction quality regarding a positional shift including a plurality of edges.

“Illustrated Blu-ray Disc Reader”, Ohmsha, Ltd. describes that for a 12-cm optical disc medium for blue laser having a recording capacity per layer of 33.3 GB, the PR12221ML method needs to be adopted. Japanese Laid-Open Patent Publication No. 2004-335079 describes that the proposed index is applicable to the PR12221ML method.

When the PR12221ML method is used for an optical disc medium using RLL(1,7) as a recording code, the shortest marks are present in succession, and there is a pattern in which the square of the Euclidean distance between two ideal signals, i.e., a state transition matrix having the maximum likelihood and a state transition matrix having the second maximum likelihood, is 12.

The pattern in which the square of the Euclidean distance is 12 will be described later in detail.

The pattern in which the square of the Euclidean distance is 12 includes the shortest marks which are detected as a pattern including a plurality of edges as shown in FIG. 17.

It is now possible to provide an index representing a detection signal including information on a plurality of edge shifts which are detected by the PRML signal processing. However, provision of an index representing how each edge is shifted has not considered so far.

### SUMMARY OF THE INVENTION

The present invention for solving the above-described problems of the conventional art has an object of providing a method and an apparatus for evaluating a recording and reproduction quality by classifying detection signals including a plurality of edges into patterns and providing an index for evaluating various positional shifts caused in a high density information recording medium by inter-code interference of recording marks or interference of heat which is used for recording information on the information recording medium. The method and apparatus for achieving the object have the structures described in items 1 through 18 below.

1. A signal evaluation method according to the present invention is a signal evaluation method, usable for an information recording medium having a data sequence including a mark and a space located alternately, for generating a binary signal from a signal obtained by reproducing the data sequence using a PRML signal processing method and evaluating a likelihood of the binary signal, the signal evaluation method comprising: a differential metric calculation step of calculating, from the binary signal, a differential metric which is a difference of a reproduction signal from a first state transition matrix having a maximum likelihood and a second state transition matrix having a second maximum likelihood; and a step of classifying the differential metric to any of a plurality of data patterns each including at least one mark and at least one space; wherein the data pattern classification to any of a plurality of data patterns is performed using a combination of a length of a first mark included in the data sequence and a length of a first space adjacently located immediately previous or immediately subsequent to the first mark, and is further performed using a length of a second mark which is not adjacent to the first mark and located adjacent to the first space; and thus a reproduction signal quality of the information recording medium is evaluated.

2. The signal evaluation method of item 1, wherein the classification using the length of the second mark is performed only when the length of the first mark is equal to or shorter than a prescribed length.

3. The signal evaluation method of item 1 or 2, wherein the data pattern classification is further performed using a length of a second space which is located adjacent to neither the first mark nor the first space and located adjacent to the second mark.

4. The signal evaluation method of item 3, wherein the classification using the length of the second space is performed only when the length of the second mark is equal to or shorter than the prescribed length.

5. The present invention is also directed to a signal evaluation method, usable for an information recording medium having a data sequence including a mark and a space located alternately, for generating a binary signal from a signal obtained by reproducing the data sequence using a PRML signal processing method and evaluating a likelihood of the binary signal, the signal evaluation method comprising: a differential metric calculation step of calculating, from the binary signal, a differential metric which is a difference of a reproduction signal from a first state transition matrix having a maximum likelihood and a second state transition matrix having a second maximum likelihood; and a step of classifying the differential metric to any of a plurality of data patterns each including at least one mark and at least one space; wherein the data pattern classification to any of a plurality of data patterns is performed using a combination of a length of a first mark included in the data sequence and a length of a first space adjacently located immediately previous or immediately subsequent to the first mark, and is further performed using a length of a third space which is not adjacent to the first space and located adjacent to the first mark; and thus a reproduction signal quality of the information recording medium is evaluated.

6. The signal evaluation method of item 5, wherein the classification using the length of the third space is performed only when the length of the first mark is equal to or shorter than a prescribed length.

7. The signal evaluation method of item 5 or 6, wherein the data pattern classification is further performed using a length of a third space which is located adjacent to neither the first mark nor the first space and located adjacent to the third space.

8. The signal evaluation method of item 7, wherein the classification using the length of the third mark is performed only when the length of the third space is equal to or shorter than the prescribed length.

9. The signal evaluation method of item 2, 4, 7 or 9, wherein the prescribed length is a shortest mark length in the data sequence.

10. The present invention is also directed to an information reproduction apparatus, usable for an information recording medium having a data sequence including a mark and a space located alternately, for generating a binary signal from a signal obtained by reproducing the data sequence using a PRML signal processing method and evaluating a likelihood of the binary signal, the information reproduction apparatus comprising: a differential metric calculation section for calculating, from the binary signal, a differential metric which is a difference of a reproduction signal from a first state transition matrix having a maximum likelihood and a second state transition matrix having a second maximum likelihood; and a pattern detection section for classifying the differential metric to any of a plurality of data patterns each including at least one mark and at least one space; wherein the data pattern classification to any of a plurality of data patterns is performed using a combination of a length of a first mark included in the data sequence and a length of a first space adjacently located immediately previous or immediately subsequent to the first mark, and is further performed using a length of a second mark which is not adjacent to the first mark and located adjacent to the first space; and thus a reproduction signal quality of the information recording medium is evaluated.

11. The information reproduction apparatus of item 10, wherein the classification using the length of the second mark is performed only when the length of the first mark is equal to or shorter than a prescribed length.

12. The information reproduction apparatus of item 10 or 11, wherein the data pattern classification is further performed using a length of a second space which is located adjacent to neither the first mark nor the first space and located adjacent to the second mark.

13. The information reproduction apparatus of item 12, wherein the classification using the length of the second space is performed only when the length of the second mark is equal to or shorter than the prescribed length.

14. The present invention is also directed to an information reproduction apparatus, usable for an information recording medium having a data sequence including a mark and a space located alternately, for generating a binary signal from a signal obtained by reproducing the data sequence using a PRML signal processing method and evaluating a likelihood of the binary signal, the information reproduction apparatus comprising: a differential metric calculation section for calculating, from the binary signal, a differential metric which is a difference of a reproduction signal from a first state transition matrix having a maximum likelihood and a second state transition matrix having a second maximum likelihood; and a pattern detection section for classifying the differential metric to any of a plurality of data patterns each including at least one mark and at least one space; wherein the data pattern classification to any of a plurality of data patterns is performed using a combination of a length of a first mark included in the data sequence and a length of a first space adjacently located immediately previous or immediately subsequent to the first mark, and is further performed using a length of a third space which is not adjacent to the first space and located adjacent to the first mark; and thus a reproduction signal quality of the information recording medium is evaluated.

15. The information reproduction apparatus of item 14, wherein the classification using the length of the third space is performed only when the length of the first mark is equal to or shorter than a prescribed length.

16. The information reproduction apparatus of item 14 or 15, wherein the data pattern classification is further performed using a length of a third space which is located adjacent to neither the first mark nor the first space and located adjacent to the third space.

17. The information reproduction apparatus of item 16, wherein the classification using the length of the third mark is performed only when the length of the third space is equal to or shorter than the prescribed length.

18. The information reproduction apparatus of item 11, 13, 15 or 17, wherein the prescribed length is a shortest mark length in the data sequence.

The data pattern classification may be further performed using a length of a second space which is located adjacent to neither the first mark nor the first space and located adjacent to the second mark.

The present invention is directed to a signal evaluation method, usable for an information recording medium having a data sequence including a mark and a space located alternately, for generating a binary signal from a signal obtained by reproducing the data sequence using a PRML signal processing method and evaluating a likelihood of the binary signal. From the binary signal, a differential metric which is a difference of a reproduction signal from a first state transition matrix having a maximum likelihood and a second state transition matrix having a second maximum likelihood is calculated. The differential metric is classified to any of a plurality of data patterns each including at least one mark and at least one space. The data pattern classification to any of a plurality of data patterns is performed using a combination of a length of a first mark included in the data sequence and a length of a first space adjacently located immediately previous or immediately subsequent to the first mark, and is further performed using a length of a second mark which is not adjacent to the first mark and located adjacent to the first space. Thus, a reproduction signal quality of the information recording medium is evaluated, and an index for an edge shift of each data pattern including at least one edge can be provided.

The present invention is also directed to a signal evaluation method, usable for an information recording medium having a data sequence including a mark and a space located alternately, for generating a binary signal from a signal obtained by reproducing the data sequence using a PRML signal processing method and evaluating a likelihood of the binary signal. From the binary signal, a differential metric which is a difference of a reproduction signal from a first state transition matrix having a maximum likelihood and a second state transition matrix having a second maximum likelihood is calculated. The differential metric is classified to any of a plurality of data patterns each including at least one mark and at least one space. The data pattern classification to any of a plurality of data patterns is performed using a combination of a length of a first mark included in the data sequence and a length of a first space adjacently located immediately previous or immediately subsequent to the first mark, and is further performed using a length of a third space which is not adjacent to the first space and located adjacent to the first mark. Thus, a reproduction signal quality of the information recording medium is evaluated, and an index for an edge shift of each data pattern including at least one edge can be provided.

### BRIEF DESCRIPTION OF THE DRAWINGS

FIG. 1 shows an optical disc apparatus according to an embodiment of the present invention.

FIG. 2 shows a state transition rule defined by the RLL(1,7) recording code and the equalization method PR(1,2,2,2,1) according to the embodiment of the present invention.

FIG. 3 is a trellis diagram corresponding to the state transition rule shown in FIG. 2.

FIG. 4 shows PR equalization ideal waveforms shown in Table 1 according to the embodiment of the present invention.

FIG. 5 is PR equalization ideal waveforms shown in Table according to the embodiment of the present invention.

FIG. 6 is PR equalization ideal waveforms shown in Table according to the embodiment of the present invention.

FIG. 7 shows classification into detailed patterns of differential metrics having a 14-detection pattern by PR(1,2,2,2,1)ML according to the embodiment of the present invention.

FIG. 8 shows classification into detailed patterns of differential metrics having a 12A-detection pattern by PR(1,2,2,2,1)ML according to the embodiment of the present invention.

FIG. 9 shows classification into detailed patterns of differential metrics having a 12B-detection pattern by PR(1,2,2,2,1)ML according to the embodiment of the present invention.

FIG. 10 shows a differential metric distribution by PR(1,2,2,2,1)ML according to the embodiment of the present invention.

FIG. 11 shows a differential metric distribution of each Euclidean distance pattern by PR(1,2,2,2,1)ML according to the embodiment of the present invention.

FIG. 12 shows examples of correlation of PR equalization ideal waveforms/reproduction waveform and a shift of marks regarding the 14-detection pattern shown in Table 1 according to the embodiment of the present invention.

FIG. 13 shows an example of correlation between PR equalization ideal waveforms/reproduction waveform and a shift of marks regarding the 12A-detection pattern shown in Table 2 according to the embodiment of the present invention.

FIG. 14 shows an example of correlation between PR equalization ideal waveforms/reproduction waveform and a shift of marks regarding the 12B-detection pattern shown in Table 3 according to the embodiment of the present invention.

FIG. 15 shows an example of distributions of differential metrics of different patterns.

FIG. 16 shows examples of relationship between an optical spot size and the mark length.

FIG. 17 shows examples of relationship between an optical spot size and a pattern including a plurality of edges.

### DETAILED DESCRIPTION OF PREFERRED EMBODIMENTS

Hereinafter, embodiments of the present invention will be described with reference to the drawings. Identical elements bear identical reference numerals, and identical descriptions thereof will be omitted.

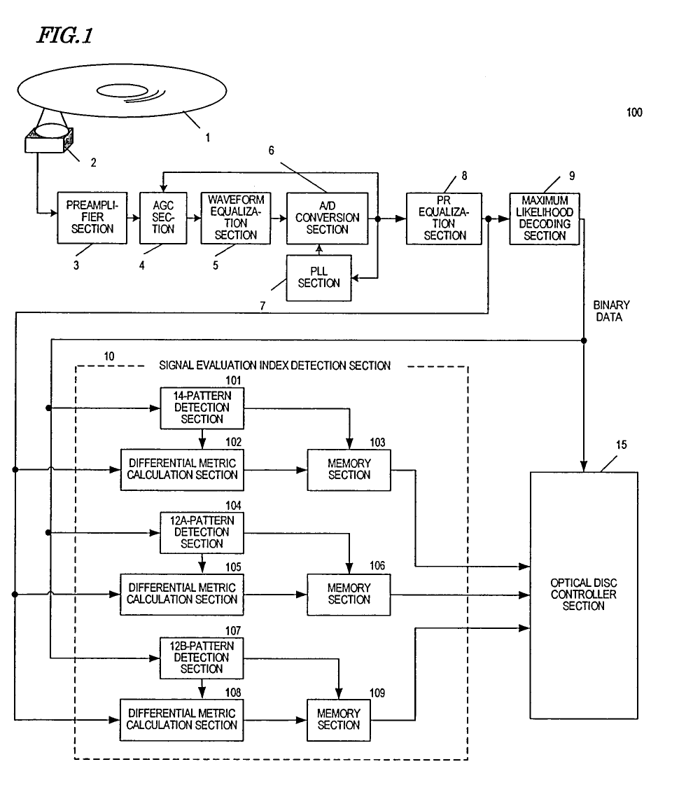

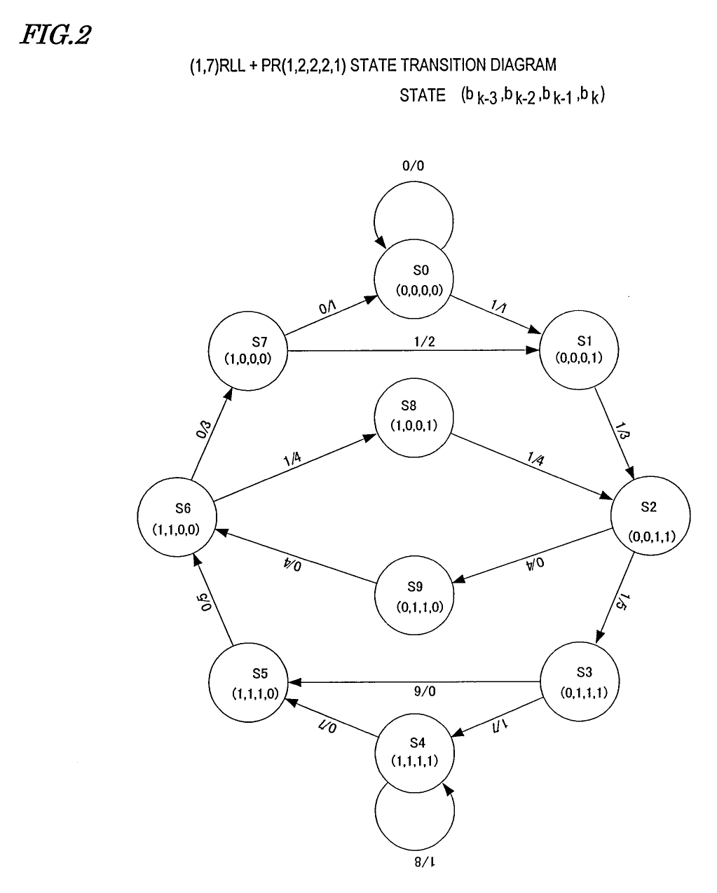

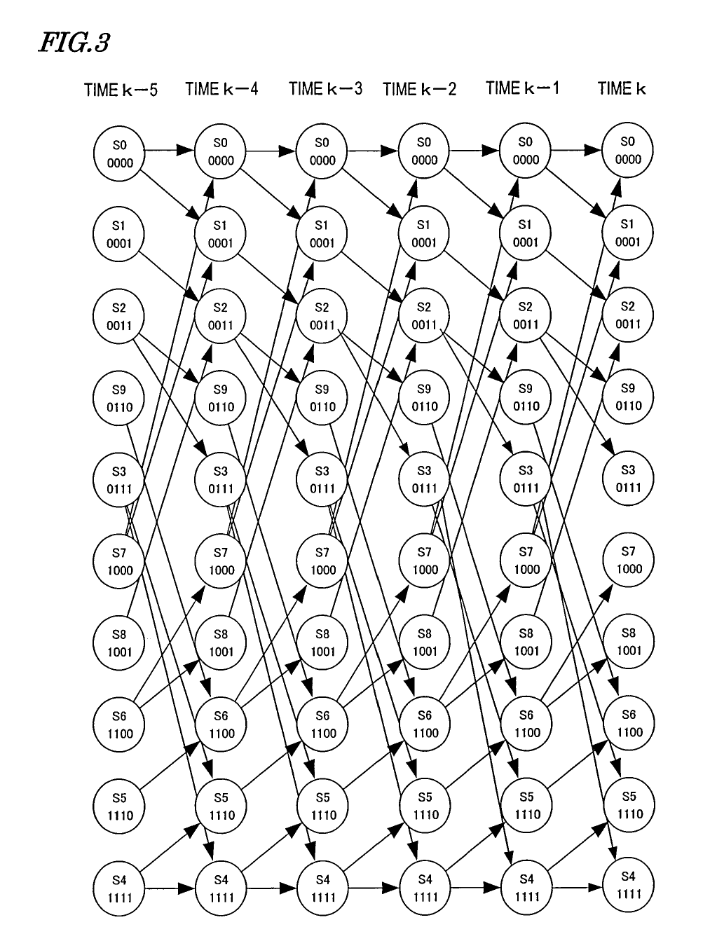

With reference to FIG. 1, a signal evaluation apparatus using a PRML method according to an embodiment of the present invention will be described. In the signal evaluation apparatus, a PR12221ML method is adopted for signal processing of a reproduction system, and an RLL (Run Length Limited) code such as an RLL(1,7) code is used as a recording code. First, with reference to FIG. 2 and FIG. 3, PR12221ML will be described briefly. FIG. 2 is a state transition diagram showing a state transition rule defined by the RLL(1,7) recording code and the equalization method PR(1,2,2,2,1). FIG. 3 is a trellis diagram corresponding to the state transition diagram shown in FIG. 2.

By the combination of PR12221ML and RLL(1,7), the number of states in a decoding section is limited to 10, the number of state transition paths is 16, and the number of reproduction levels are 9.

Referring to the state transition rule of PR12221 shown in FIG. 2, ten states at a certain time are represented as follows. State S(0,0,0,0) is represented as “0, state S(0,0,0,1) is represented as S1, state S(0,0,1,1) is represented as S2, state S(0,1,1,1) is represented as S3, state S(1,1,1,1) is represented as S4, state S(1,1,1,0) is represented as S5, state S(1,1,0,0) is represented as S6, state S(1,0,0,0) is represented as S7, state S(1,0,0,1) is represented as S8, and state S(0,1,1,0) is represented as S9. “0” or “1” in parentheses represents a signal on the time axis, and represents which state will possibly occur at the next time by a state transition from one state. The trellis diagram is obtained by developing this state transition diagram along the time axis.

In the state transition of PR12221ML shown in FIG. 3, there are numerous state transition matrix patterns (state combinations) by which a prescribed state at one time is changed to another prescribed state at the next time via either one of two state transitions. However, the patterns which are highly like to cause an error are limited to specific patterns which are difficult to be distinguished. Focusing on such patterns which are likely to cause an error, the state transition matrix patterns of PR12221 can be summarized as Tables 1, 2 and 3.

TABLE 1

| | | | | | | | | | | | | | PR | | | | | Inter-path |
|---|---|---|---|---|---|---|---|---|---|---|---|---|---|---|---|---|---|---|
| | Transition data sequence | | k − | k − | k − | | | | | | | | equalization | | | | | Euclidean |
| State transition | (bₖ₋ᵢ, . . . , bₖ) | Pattern | 9 | 8 | 7 | k − 6 | k − 5 | k − 4 | k − 3 | k − 2 | k − 1 | k | ideal value | | | | | distance |
| S0ₖ₋₅ → S6ₖ | (0, 0, 0, 0, x, 1, 1, 0, 0) | [14]1A | | | | | S0 | S1 | S2 | S3 | S5 | S6 | 1 | 3 | 5 | 6 | 5 | |
| | | [14]1B | | | | | S0 | S0 | S1 | S2 | S9 | S6 | 0 | 1 | 3 | 4 | 4 | 14 |
| S0ₖ₋₅ → S5ₖ | (0, 0, 0, 0, x, 1, 1, 1, 0) | [14]2A | | | | | S0 | S1 | S2 | S3 | S4 | S5 | 1 | 3 | 5 | 7 | 7 | |
| | | [14]2B | | | | | S0 | S0 | S1 | S2 | S3 | S5 | 0 | 1 | 3 | 5 | 6 | 14 |
| S0ₖ₋₅ → S4ₖ | (0, 0, 0, 0, x, 1, 1, 1, 1) | [14]3A | | | | | S0 | S1 | S2 | S3 | S4 | S4 | 1 | 3 | 5 | 7 | 8 | |
| | | [14]3B | | | | | S0 | S0 | S1 | S2 | S3 | S4 | 0 | 1 | 3 | 5 | 7 | 14 |
| S2ₖ₋₅ → S0ₖ | (0, 0, 1, 1, x, 0, 0, 0, 0) | [14]4A | | | | | S2 | S3 | S5 | S6 | S7 | S0 | 5 | 6 | 5 | 3 | 1 | |
| | | [14]4B | | | | | S2 | S9 | S6 | S7 | S0 | S0 | 4 | 4 | 3 | 1 | 0 | 14 |
| S2ₖ₋₅ → S1ₖ | (0, 0, 1, 1, x, 0, 0, 0, 1) | [14]5A | | | | | S2 | S3 | S5 | S6 | S7 | S1 | 5 | 6 | 5 | 3 | 2 | |
| | | [14]5B | | | | | S2 | S9 | S6 | S7 | S0 | S1 | 4 | 4 | 3 | 1 | 1 | 14 |
| S2ₖ₋₅ → S2ₖ | (0, 0, 1, 1, x, 0, 0, 1, 1) | [14]6A | | | | | S2 | S3 | S5 | S6 | S8 | S2 | 5 | 6 | 5 | 4 | 4 | |
| | | [14]6B | | | | | S2 | S9 | S6 | S7 | S1 | S2 | 4 | 4 | 3 | 2 | 3 | 14 |
| S3ₖ₋₅ → S0ₖ | (0, 1, 1, 1, x, 0, 0, 0, 0) | [14]7A | | | | | S3 | S4 | S5 | S6 | S7 | S0 | 7 | 7 | 5 | 3 | 1 | |
| | | [14]7B | | | | | S3 | S5 | S6 | S7 | S0 | S0 | 6 | 5 | 3 | 1 | 0 | 14 |
| S3ₖ₋₅ → S1ₖ | (0, 1, 1, 1, x, 0, 0, 0, 1) | [14]8A | | | | | S3 | S4 | S5 | S6 | S7 | S1 | 7 | 7 | 5 | 3 | 2 | |
| | | [14]8B | | | | | S3 | S5 | S6 | S7 | S0 | S1 | 6 | 5 | 3 | 1 | 1 | 14 |
| S3ₖ₋₅ → S2ₖ | (0, 1, 1, 1, x, 0, 0, 1, 1) | [14]9A | | | | | S3 | S4 | S5 | S6 | S8 | S2 | 7 | 7 | 5 | 4 | 4 | |
| | | [14]9B | | | | | S3 | S5 | S6 | S7 | S1 | S2 | 6 | 5 | 3 | 2 | 3 | 14 |
| S7ₖ₋₅ → S6ₖ | (1, 0, 0, 0, x, 1, 1, 0, 0) | [14]10A | | | | | S7 | S1 | S2 | S3 | S5 | S6 | 2 | 3 | 5 | 6 | 5 | |
| | | [14]10B | | | | | S7 | S0 | S1 | S2 | S9 | S6 | 1 | 1 | 3 | 4 | 4 | 14 |
| S7ₖ₋₅ → S5ₖ | (1, 0, 0, 0, x, 1, 1, 1, 0) | [14]11A | | | | | S7 | S1 | S2 | S3 | S4 | S5 | 2 | 3 | 5 | 7 | 7 | |
| | | [14]11B | | | | | S7 | S0 | S1 | S2 | S3 | S5 | 1 | 1 | 3 | 5 | 6 | 14 |
| S7ₖ₋₅ → S4ₖ | (1, 0, 0, 0, x, 1, 1, 1, 1) | [14]12A | | | | | S7 | S1 | S2 | S3 | S4 | S4 | 2 | 3 | 5 | 7 | 8 | |
| | | [14]12B | | | | | S7 | S0 | S1 | S2 | S3 | S4 | 1 | 1 | 3 | 5 | 7 | 14 |
| S6ₖ₋₅ → S6ₖ | (1, 1, 0, 0, x, 1, 1, 0, 0) | [14]13A | | | | | S6 | S8 | S2 | S3 | S5 | S6 | 4 | 4 | 5 | 6 | 5 | |
| | | [14]13B | | | | | S6 | S7 | S1 | S2 | S9 | S6 | 3 | 2 | 3 | 4 | 4 | 14 |
| S6ₖ₋₅ → S5ₖ | (1, 1, 0, 0, x, 1, 1, 1, 0) | [14]14A | | | | | S6 | S8 | S2 | S3 | S4 | S5 | 4 | 4 | 5 | 7 | 7 | |
| | | [14]14B | | | | | S6 | S7 | S1 | S2 | S3 | S5 | 3 | 2 | 3 | 5 | 6 | 14 |
| S6ₖ₋₅ → S4ₖ | (1, 1, 0, 0, x, 1, 1, 1, 1) | [14]15A | | | | | S6 | S8 | S2 | S3 | S4 | S4 | 4 | 4 | 5 | 7 | 8 | |
| | | [14]15B | | | | | S6 | S7 | S1 | S2 | S3 | S4 | 3 | 2 | 3 | 5 | 7 | 14 |
| S4ₖ₋₅ → S0ₖ | (1, 1, 1, 1, x, 0, 0, 0, 0) | [14]16A | | | | | S4 | S4 | S5 | S6 | S7 | S0 | 8 | 7 | 5 | 3 | 1 | |
| | | [14]16B | | | | | S4 | S5 | S6 | S7 | S0 | S0 | 7 | 5 | 3 | 1 | 0 | 14 |
| S4ₖ₋₅ → S1ₖ | (1, 1, 1, 1, x, 0, 0, 0, 1) | [14]17A | | | | | S4 | S4 | S5 | S6 | S7 | S1 | 8 | 7 | 5 | 3 | 2 | |
| | | [14]17B | | | | | S4 | S5 | S6 | S7 | S0 | S1 | 7 | 5 | 3 | 1 | 1 | 14 |
| S4ₖ₋₅ → S2ₖ | (1, 1, 1, 1, x, 0, 0, 1, 1) | [14]18A | | | | | S4 | S4 | S5 | S6 | S8 | S2 | 8 | 7 | 5 | 4 | 4 | |
| | | [14]18B | | | | | S4 | S5 | S6 | S7 | S1 | S2 | 7 | 5 | 3 | 2 | 3 | 14 |

TABLE 2

| | | | | | | | | | | | | | | | | | | | | Inter-path |
|---|---|---|---|---|---|---|---|---|---|---|---|---|---|---|---|---|---|---|---|---|
| State | Transition data | | k − | k − | k − | k − | k − | k − | k − | k − | k − | | PR | | | | | | | Euclidean |
| transition | sequence (bₖ₋ᵢ, . . . , bₖ) | Pattern | 9 | 8 | 7 | 6 | 5 | 4 | 3 | 2 | 1 | k | equalization ideal value | | | | | | | distance |
| S0ₖ₋₇ → S0ₖ | (0, 0, 0, 0, x, 1, !x, 0, 0, 0, 0) | [12A]1A | | | S0 | S1 | S2 | S9 | S6 | S7 | S0 | S0 | 1 | 3 | 4 | 4 | 3 | 1 | 0 | |
| | | [12A]1B | | | S0 | S0 | S1 | S2 | S9 | S6 | S7 | S0 | 0 | 1 | 3 | 4 | 4 | 3 | 1 | 12 |
| S0ₖ₋₇ → S1ₖ | (0, 0, 0, 0, x, 1, !x, 0, 0, 0, 1) | [12A]2A | | | S0 | S1 | S2 | S9 | S6 | S7 | S0 | S1 | 1 | 3 | 4 | 4 | 3 | 1 | 1 | |
| | | [12A]2B | | | S0 | S0 | S1 | S2 | S9 | S6 | S7 | S1 | 0 | 1 | 3 | 4 | 4 | 3 | 2 | 12 |
| S0ₖ₋₇ → S2ₖ | (0, 0, 0, 0, x, 1, !x, 0, 0, 1, 1) | [12A]3A | | | S0 | S1 | S2 | S9 | S6 | S7 | S1 | S2 | 1 | 3 | 4 | 4 | 3 | 2 | 3 | |
| | | [12A]3B | | | S0 | S0 | S1 | S2 | S9 | S6 | S8 | S2 | 0 | 1 | 3 | 4 | 4 | 4 | 4 | 12 |
| S2ₖ₋₇ → S6ₖ | (0, 0, 1, 1, x, 0, !x, 1, 1, 0, 0) | [12A]4A | | | S2 | S3 | S5 | S6 | S8 | S2 | S9 | S6 | 5 | 6 | 5 | 4 | 4 | 4 | 4 | |
| | | [12A]4B | | | S2 | S9 | S6 | S8 | S2 | S3 | S5 | S6 | 4 | 4 | 4 | 4 | 5 | 6 | 5 | 12 |
| S2ₖ₋₇ → S5ₖ | (0, 0, 1, 1, x, 0, !x, 1, 1, 1, 0) | [12A]5A | | | S2 | S3 | S5 | S6 | S8 | S2 | S3 | S5 | 5 | 6 | 5 | 4 | 4 | 5 | 6 | |
| | | [12A]5B | | | S2 | S9 | S6 | S8 | S2 | S3 | S4 | S5 | 4 | 4 | 4 | 4 | 5 | 7 | 7 | 12 |
| S2ₖ₋₇ → S4ₖ | (0, 0, 1, 1, x, 0, !x, 1, 1, 1, 1) | [12A]6A | | | S2 | S3 | S5 | S6 | S8 | S2 | S3 | S4 | 5 | 6 | 5 | 4 | 4 | 5 | 7 | |
| | | [12A]6B | | | S2 | S9 | S6 | S8 | S2 | S3 | S4 | S4 | 4 | 4 | 4 | 4 | 5 | 7 | 8 | 12 |
| S3ₖ₋₇ → S6ₖ | (0, 1, 1, 1, x, 0, !x, 1, 1, 0, 0) | [12A]7A | | | S3 | S4 | S5 | S6 | S8 | S2 | S9 | S6 | 7 | 7 | 5 | 4 | 4 | 4 | 4 | |
| | | [12A]7B | | | S3 | S5 | S6 | S8 | S2 | S3 | S5 | S6 | 6 | 5 | 4 | 4 | 5 | 6 | 5 | 12 |
| S3ₖ₋₇ → S5ₖ | (0, 1, 1, 1, x, 0, !x, 1, 1, 1, 0) | [12A]8A | | | S3 | S4 | S5 | S6 | S8 | S2 | S3 | S5 | 7 | 7 | 5 | 4 | 4 | 5 | 6 | |
| | | [12A]8B | | | S3 | S5 | S6 | S8 | S2 | S3 | S4 | S5 | 6 | 5 | 4 | 4 | 5 | 7 | 7 | 12 |
| S3ₖ₋₇ → S4ₖ | (0, 1, 1, 1, x, 0, !x, 1, 1, 1, 1) | [12A]9A | | | S3 | S4 | S5 | S6 | S8 | S2 | S3 | S4 | 7 | 7 | 5 | 4 | 4 | 5 | 7 | |
| | | [12A]9B | | | S3 | S5 | S6 | S8 | S2 | S3 | S4 | S4 | 6 | 5 | 4 | 4 | 5 | 7 | 8 | 12 |
| S7ₖ₋₇ → S0ₖ | (1, 0, 0, 0, x, 1, !x, 0, 0, 0, 0) | [12A]10A | | | S7 | S1 | S2 | S9 | S6 | S7 | S0 | S0 | 2 | 3 | 4 | 4 | 3 | 1 | 0 | |
| | | [12A]10B | | | S7 | S0 | S1 | S2 | S9 | S6 | S7 | S0 | 1 | 1 | 3 | 4 | 4 | 3 | 1 | 12 |
| S7ₖ₋₇ → S1ₖ | (1, 0, 0, 0, x, 1, !x, 0, 0, 0, 1) | [12A]11A | | | S7 | S1 | S2 | S9 | S6 | S7 | S0 | S1 | 2 | 3 | 4 | 4 | 3 | 1 | 1 | |
| | | [12A]11B | | | S7 | S0 | S1 | S2 | S9 | S6 | S7 | S1 | 1 | 1 | 3 | 4 | 4 | 3 | 2 | 12 |
| S7ₖ₋₇ → S2ₖ | (1, 0, 0, 0, x, 1, !x, 0, 0, 1, 1) | [12A]12A | | | S7 | S1 | S2 | S9 | S6 | S7 | S1 | S2 | 2 | 3 | 4 | 4 | 3 | 2 | 3 | |
| | | [12A]12B | | | S7 | S0 | S1 | S2 | S9 | S6 | S8 | S2 | 1 | 1 | 3 | 4 | 4 | 4 | 4 | 12 |
| S6ₖ₋₇ → S0ₖ | (1, 1, 0, 0, x, 1, !x, 0, 0, 0, 0) | [12A]13A | | | S6 | S8 | S2 | S9 | S6 | S7 | S0 | S0 | 4 | 4 | 4 | 4 | 3 | 1 | 0 | |
| | | [12A]13B | | | S6 | S7 | S1 | S2 | S9 | S6 | S7 | S0 | 3 | 2 | 3 | 4 | 4 | 3 | 1 | 12 |
| S6ₖ₋₇ → S1ₖ | (1, 1, 0, 0, x, 1, !x, 0, 0, 0, 1) | [12A]14A | | | S6 | S8 | S2 | S9 | S6 | S7 | S0 | S1 | 4 | 4 | 4 | 4 | 3 | 1 | 1 | |
| | | [12A]14B | | | S6 | S7 | S1 | S2 | S9 | S6 | S7 | S1 | 3 | 2 | 3 | 4 | 4 | 3 | 2 | 12 |
| S6ₖ₋₇ → S2ₖ | (1, 1, 0, 0, x, 1, !x, 0, 0, 1, 1) | [12A]15A | | | S6 | S8 | S2 | S9 | S6 | S7 | S1 | S2 | 4 | 4 | 4 | 4 | 3 | 2 | 3 | |
| | | [12A]15B | | | S6 | S7 | S1 | S2 | S9 | S6 | S8 | S2 | 3 | 2 | 3 | 4 | 4 | 4 | 4 | 12 |
| S4ₖ₋₇ → S6ₖ | (1, 1, 1, 1, x, 0, !x, 1, 1, 0, 0) | [12A]16A | | | S4 | S4 | S5 | S6 | S8 | S2 | S9 | S6 | 8 | 7 | 5 | 4 | 4 | 4 | 4 | |
| | | [12A]16B | | | S4 | S5 | S6 | S8 | S2 | S3 | S5 | S6 | 7 | 5 | 4 | 4 | 5 | 6 | 5 | 12 |
| S4ₖ₋₇ → S5ₖ | (1, 1, 1, 1, x, 0, !x, 1, 1, 1, 0) | [12A]17A | | | S4 | S4 | S5 | S6 | S8 | S2 | S3 | S5 | 8 | 7 | 5 | 4 | 4 | 5 | 6 | |
| | | [12A]17B | | | S4 | S5 | S6 | S8 | S2 | S3 | S4 | S5 | 7 | 5 | 4 | 4 | 5 | 7 | 7 | 12 |
| S4ₖ₋₇ → S4ₖ | (1, 1, 1, 1, x, 0, !x, 1, 1, 1, 1) | [12A]18A | | | S4 | S4 | S5 | S6 | S8 | S2 | S3 | S4 | 8 | 7 | 5 | 4 | 4 | 5 | 7 | |
| | | [12A]18B | | | S4 | S5 | S6 | S8 | S2 | S3 | S4 | S4 | 7 | 5 | 4 | 4 | 5 | 7 | 8 | 12 |

TABLE 3

| | Transition | | | | | | | | | | | | | | | | | | | | | Inter-path |
|---|---|---|---|---|---|---|---|---|---|---|---|---|---|---|---|---|---|---|---|---|---|---|
| State | data sequence | | k − | k − | k − | k − | k − | k − | k − | k − | k − | | | | | | | | | | | Euclidean |
| transition | (bₖ₋ᵢ, . . . , bₖ) | Pattern | 9 | 8 | 7 | 6 | 5 | 4 | 3 | 2 | 1 | k | PR equalization ideal value | | | | | | | | | distance |
| S0ₖ₋₉ → S6ₖ | (0, 0, 0, 0, x, 1, !x, | [12B]1A | S0 | S1 | S2 | S9 | S6 | S8 | S2 | S3 | S5 | S6 | 1 | 3 | 4 | 4 | 4 | 4 | 5 | 6 | 5 | |
| | 0, x, 1, 1, 0, 0) | [12B]1B | S0 | S0 | S1 | S2 | S9 | S6 | S8 | S2 | S9 | S6 | 0 | 1 | 3 | 4 | 4 | 4 | 4 | 4 | 4 | 12 |
| S0ₖ₋₉ → S5ₖ | (0, 0, 0, 0, x, 1, !x, | [12B]2A | S0 | S1 | S2 | S9 | S6 | S8 | S2 | S3 | S4 | S5 | 1 | 3 | 4 | 4 | 4 | 4 | 5 | 7 | 7 | |
| | 0, x, 1, 1, 1, 0) | [12B]2B | S0 | S0 | S1 | S2 | S9 | S6 | S8 | S2 | S3 | S5 | 0 | 1 | 3 | 4 | 4 | 4 | 4 | 5 | 6 | 12 |
| S0ₖ₋₉ → S4ₖ | (0, 0, 0, 0, x, 1, !x, | [12B]3A | S0 | S1 | S2 | S9 | S6 | S8 | S2 | S3 | S4 | S4 | 1 | 3 | 4 | 4 | 4 | 4 | 5 | 7 | 8 | |
| | 0, x, 1, 1, 1, 1) | [12B]3B | S0 | S0 | S1 | S2 | S9 | S6 | S8 | S2 | S3 | S4 | 0 | 1 | 3 | 4 | 4 | 4 | 4 | 5 | 7 | 12 |
| S2ₖ₋₇ → S0ₖ | (0, 0, 1, 1, x, 0, !x, | [12B]4A | S2 | S3 | S5 | S6 | S8 | S2 | S9 | S6 | S7 | S0 | 5 | 6 | 5 | 4 | 4 | 4 | 4 | 3 | 1 | |
| | 1, x, 0, 0, 0, 0) | [12B]4B | S2 | S9 | S6 | S8 | S2 | S9 | S6 | S7 | S0 | S0 | 4 | 4 | 4 | 4 | 4 | 4 | 3 | 1 | 0 | 12 |
| S2ₖ₋₇ → S1ₖ | (0, 0, 1, 1, x, 0, !x, | [12B]5A | S2 | S3 | S5 | S6 | S8 | S2 | S9 | S6 | S7 | S1 | 5 | 6 | 5 | 4 | 4 | 4 | 4 | 3 | 2 | |
| | 1, x, 0, 0, 0, 1) | [12B]5B | S2 | S9 | S6 | S8 | S2 | S9 | S6 | S7 | S0 | S1 | 4 | 4 | 4 | 4 | 4 | 4 | 3 | 1 | 1 | 12 |
| S2ₖ₋₇ → S2ₖ | (0, 0, 1, 1, x, 0, !x, | [12B]6A | S2 | S3 | S5 | S6 | S8 | S2 | S9 | S6 | S8 | S2 | 5 | 6 | 5 | 4 | 4 | 4 | 4 | 4 | 4 | |
| | 1, x, 0, 0, 1, 1) | [12B]6B | S2 | S9 | S6 | S8 | S2 | S9 | S6 | S7 | S1 | S2 | 4 | 4 | 4 | 4 | 4 | 4 | 3 | 2 | 3 | 12 |
| S3ₖ₋₅ → S0ₖ | (0, 1, 1, 1, x, 0, !x, | [12B]7A | S3 | S4 | S5 | S6 | S8 | S2 | S9 | S6 | S7 | S0 | 7 | 7 | 5 | 4 | 4 | 4 | 4 | 3 | 1 | |
| | 1, x, 0, 0, 0, 0) | [12B]7B | S3 | S5 | S6 | S8 | S2 | S9 | S6 | S7 | S0 | S0 | 6 | 5 | 4 | 4 | 4 | 4 | 3 | 1 | 0 | 12 |
| S3ₖ₋₅ → S1ₖ | (0, 1, 1, 1, x, 0, !x, | [12B]8A | S3 | S4 | S5 | S6 | S8 | S2 | S9 | S6 | S7 | S1 | 7 | 7 | 5 | 4 | 4 | 4 | 4 | 3 | 2 | |
| | 1, x, 0, 0, 0, 1) | [12B]8B | S3 | S5 | S6 | S8 | S2 | S9 | S6 | S7 | S0 | S1 | 6 | 5 | 4 | 4 | 4 | 4 | 3 | 1 | 1 | 12 |
| S3ₖ₋₅ → S2ₖ | (0, 1, 1, 1, x, 0, !x, | [12B]9A | S3 | S4 | S5 | S6 | S8 | S2 | S9 | S6 | S8 | S2 | 7 | 7 | 5 | 4 | 4 | 4 | 4 | 4 | 4 | |
| | 1, x, 0, 0, 1, 1) | [12B]9B | S3 | S5 | S6 | S8 | S2 | S9 | S6 | S7 | S1 | S2 | 6 | 5 | 4 | 4 | 4 | 4 | 3 | 2 | 3 | 12 |
| S7ₖ₋₅ → S6ₖ | (1, 0, 0, 0, x, 1, !x, | [12B]10A | S7 | S1 | S2 | S9 | S6 | S8 | S2 | S3 | S5 | S6 | 2 | 3 | 4 | 4 | 4 | 4 | 5 | 6 | 5 | |
| | 0, x, 1, 1, 0, 0) | [12B]10B | S7 | S0 | S1 | S2 | S9 | S6 | S8 | S2 | S9 | S6 | 1 | 1 | 3 | 4 | 4 | 4 | 4 | 4 | 4 | 12 |
| S7ₖ₋₅ → S5ₖ | (1, 0, 0, 0, x, 1, !x, | [12B]11A | S7 | S1 | S2 | S9 | S6 | S8 | S2 | S3 | S4 | S5 | 2 | 3 | 4 | 4 | 4 | 4 | 5 | 7 | 7 | |
| | 0, x, 1, 1, 1, 0) | [12B]11B | S7 | S0 | S1 | S2 | S9 | S6 | S8 | S2 | S3 | S5 | 1 | 1 | 3 | 4 | 4 | 4 | 4 | 5 | 6 | 12 |
| S7ₖ₋₅ → S4ₖ | (1, 0, 0, 0, x, 1, !x, | [12B]12A | S7 | S1 | S2 | S9 | S6 | S8 | S2 | S3 | S4 | S4 | 2 | 3 | 4 | 4 | 4 | 4 | 5 | 7 | 8 | |
| | 0, x, 1, 1, 1, 1) | [12B]12B | S7 | S0 | S1 | S2 | S9 | S6 | S8 | S2 | S3 | S4 | 1 | 1 | 3 | 4 | 4 | 4 | 4 | 5 | 7 | 12 |
| S6ₖ₋₅ → S6ₖ | (1, 1, 0, 0, x, 1, !x, | [12B]13A | S6 | S8 | S2 | S9 | S6 | S8 | S2 | S3 | S5 | S6 | 4 | 4 | 4 | 4 | 4 | 4 | 5 | 6 | 5 | |
| | 0, x, 1, 1, 0, 0) | [12B]13B | S6 | S7 | S1 | S2 | S9 | S6 | S8 | S2 | S9 | S6 | 3 | 2 | 3 | 4 | 4 | 4 | 4 | 4 | 4 | 12 |
| S6ₖ₋₅ → S5ₖ | (1, 1, 0, 0, x, 1, !x, | [12B]14A | S6 | S8 | S2 | S9 | S6 | S8 | S2 | S3 | S4 | S5 | 4 | 4 | 4 | 4 | 4 | 4 | 5 | 7 | 7 | |
| | 0, x, 1, 1, 1, 0) | [12B]14B | S6 | S7 | S1 | S2 | S9 | S6 | S8 | S2 | S3 | S5 | 3 | 2 | 3 | 4 | 4 | 4 | 4 | 5 | 6 | 12 |
| S6ₖ₋₅ → S4ₖ | (1, 1, 0, 0, x, 1, !x, | [12B]15A | S6 | S8 | S2 | S9 | S6 | S8 | S2 | S3 | S4 | S4 | 4 | 4 | 4 | 4 | 4 | 4 | 5 | 7 | 8 | |
| | 0, x, 1, 1, 1, 1) | [12B]15B | S6 | S7 | S1 | S2 | S9 | S6 | S8 | S2 | S3 | S4 | 3 | 2 | 3 | 4 | 4 | 4 | 4 | 5 | 7 | 12 |
| S4ₖ₋₅ → S0ₖ | (1, 1, 1, 1, x, 0, !x, | [12B]16A | S4 | S4 | S5 | S6 | S8 | S2 | S9 | S6 | S7 | S0 | 8 | 7 | 5 | 4 | 4 | 4 | 4 | 3 | 1 | |
| | 1, x, 0, 0, 0, 0) | [12B]16B | S4 | S5 | S6 | S8 | S2 | S9 | S6 | S7 | S0 | S0 | 7 | 5 | 4 | 4 | 4 | 4 | 3 | 1 | 0 | 12 |
| S4ₖ₋₅ → S1ₖ | (1, 1, 1, 1, x, 0, !x, | [12B]17A | S4 | S4 | S5 | S6 | S8 | S2 | S9 | S6 | S7 | S1 | 8 | 7 | 5 | 4 | 4 | 4 | 4 | 3 | 2 | |
| | 1, x, 0, 0, 0, 1) | [12B]17B | S4 | S5 | S6 | S8 | S2 | S9 | S6 | S7 | S0 | S1 | 7 | 5 | 4 | 4 | 4 | 4 | 3 | 1 | 1 | 12 |
| S4ₖ₋₅ → S2ₖ | (1, 1, 1, 1, x, 0, !x, | [12B]18A | S4 | S4 | S5 | S6 | S8 | S2 | S9 | S6 | S8 | S2 | 8 | 7 | 5 | 4 | 4 | 4 | 4 | 4 | 4 | |
| | 1, x, 0, 0, 1, 1) | [12B]18B | S4 | S5 | S6 | S8 | S2 | S9 | S6 | S7 | S1 | S2 | 7 | 5 | 4 | 4 | 4 | 4 | 3 | 2 | 3 | 12 |

In Tables 1 through 3, the first column represents the state transition (Smₖ₋₉→Snₖ) by which two state transitions which are likely to cause an error are branched and rejoin.

The second column represents the state data sequence (bₖ₋₁, . . . , bₖ) which causes the corresponding state transition.

“X” in the demodulated data sequence represents a bit which is likely to cause an error in such data. When the corresponding state transition is determined to be an error, the number of X's (also the number of !X's) is the number of errors.

Among a transition data sequence in which X is 1 and a transition data sequence in which X is 0, one corresponds to a first state transition matrix having the maximum likelihood, and the other corresponds to a second state transition matrix having the second maximum likelihood.

In Tables 2 and 3, “!X” represents an inverted bit of X.

From the demodulated data sequences obtained by demodulation performed by a Viterbi decoding section, the first state transition matrix having the maximum likelihood of causing an error and the second state transition matrix having the second maximum likelihood of causing an error can be extracted by comparing each demodulated data sequence and the transition data sequence (X: Don't care).

The third column represents the first state transition matrix and the second state transition matrix.

The fourth column represents two ideal reproduction waveforms (PR equalization ideal values) after the respective state transitions. The fifth column represents the square of the Euclidean distance between the two ideal signals (inter-path Euclidean distance).

Among combination patterns of two possible state transitions, Table 1 shows 18 patterns by which the square of the Euclidean distance between the two possible state transitions is 14.

These patterns correspond to a portion of an optical disc medium at which a mark is switched to a space (edge of a waveform).

In other words, these patterns are 1-bit edge shift error patterns.

As an example, state transition paths from S0(k−5) to S6(k) in the state transition rule in FIG. 3 will be described.

In this case, one path in which the recording sequence is changed as “0,0,0,0,1,1,1,0,0” is detected. Considering that “0” of the reproduction data is a space and “1” of the reproduction data is a mark, this state transition path corresponds to a 4T or longer space, a 3T mark, and a 2T or longer space.

FIG. 4 shows an example of the PR equalization ideal waveforms in the recording sequence shown in Table 1. In FIG. 4, “A path waveform” represents the PR equalization ideal waveform of the above-mentioned recording sequence.

Similarly, FIG. 5 shows an example of the PR equalization ideal waveforms shown in Table 2.

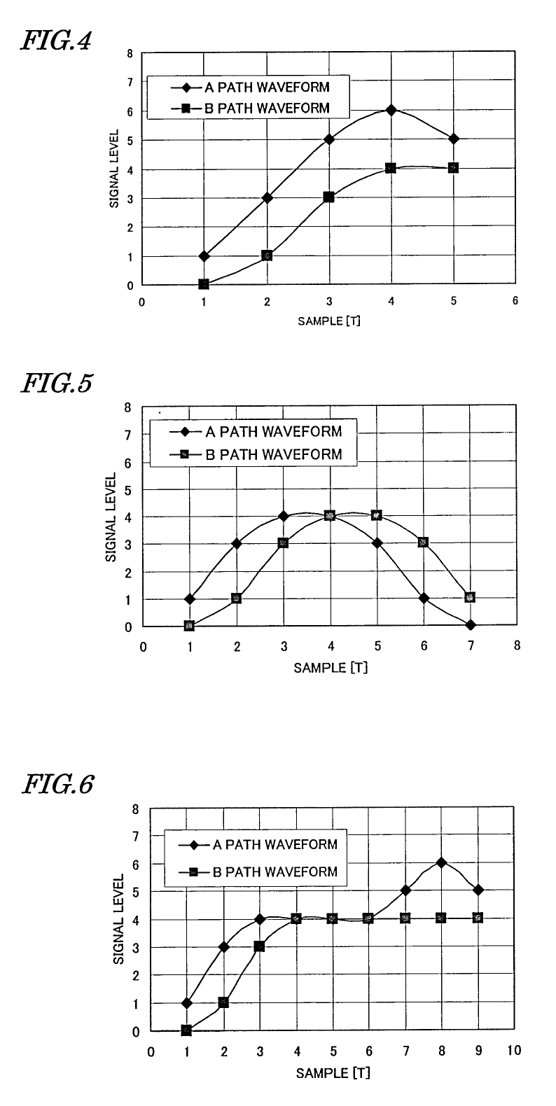

FIG. 6 shows an example of the PR equalization ideal waveforms shown in Table 3.

In FIGS. 4, 5 and 6, the horizontal axis represents the sampling time (sampled at one time unit of the recording sequence), and the vertical axis represents the reproduction signal level.

As described above, in PR12221ML, there are 9 ideal reproduction signal levels (level 0 through level 8).

In the state transition rule shown in FIG. 3, there is another path from S0(k−5) to S6(k), in which the recording sequence is changed as “0,0,0,0,0,1,1,0,0”. Considering that “0” of the reproduction data is a space and “1” of the reproduction data is a mark, this state transition path corresponds to a 5T or longer space, a 2T mark, and a 2T or longer space.

In FIG. 4, “B path waveform” represents the PR equalization ideal waveform of this path.

The patterns shown in Table 1 corresponding to the Euclidean distance of 14 have a feature of necessarily including one piece of edge information.

Table 2 shows 18 patterns by which the square of the Euclidean distance between the two possible state transitions is 12.

These patterns correspond to a shift error of a 2T mark or a 2T space; namely, are 2-bit shift error patterns.

As an example, state transition paths from S0(k−7) to S0(k) in the state transition rule in FIG. 3 will be described.

In this case, one path in which the recording sequence is changed as “0,0,0,0,1,1,0,0,0,0,0” is detected. Considering that “0” of the reproduction data is a space and “1” of the reproduction data is a mark, this state transition path corresponds to a 4T or longer space, a 2T mark, and a 5T or longer space.

In FIG. 5, “A path waveform” represents the PR equalization ideal waveform of this path.

There is another path in which the recording sequence is changed as “0,0,0,0,0,1,1,0,0,0,0”. Considering that “0” of the reproduction data is a space and “1” of the reproduction data is a mark, this state transition path corresponds to a 5T or longer space, a 2T mark, and a 4T or longer space.

In FIG. 5, “B path waveform” represents the PR equalization ideal waveform of this path.

The patterns shown in Table 2 corresponding to the Euclidean distance of 12 have a feature of necessarily including two pieces of edge information on a 2T rise and a 2T fall.

Table 3 also shows 18 patterns by which the square of the Euclidean distance between two possible state transitions is 12. The patterns in Table 3 is of a different type from the patterns in Table 2.

These patterns correspond to a portion at which a 2T mark is continuous to a 2T space; namely, are 3-bit error patterns.

As an example, state transition paths from S0(k−9) to S6(k) in the state transition rule in FIG. 3 will be described.

In this case, one path in which the recording sequence is changed as “0,0,0,0,1,1,0,0,1,1,1,0,0” is detected. Considering that “0” of the reproduction data is a space and “1” of the reproduction data is a mark, this state transition path corresponds to a 4T or longer space, a 2T mark, a 2T space, a 3T mark, and a 2T or longer space.

In FIG. 6, “A path waveform” represents the PR equalization ideal waveform of this path.

There is another path in which the recording sequence is changed as “0,0,0,0,0,1,1,0,0,1,1,0,0”. Considering that “0” of the reproduction data is a space and “1” of the reproduction data is a mark, this state transition path corresponds to a 5T or longer space, a 2T mark, a 2T space, a 2T mark, and a 2T or longer space.

In FIG. 6, “B path waveform” represents the PR equalization ideal waveform of this path.

The patterns shown in Table 3 corresponding to the square of the Euclidean distance of 12 have a feature of including at least three pieces of edge information.

### Embodiment 1

Now, an optical disc apparatus according to an embodiment of the present invention will be described.

FIG. 1 shows an optical disc apparatus 100 according to Embodiment 1 of the present invention.

The optical disc apparatus 100 reproduces information from an information recording medium 1 mounted thereon or records information to the information recording medium 1.

The information recording medium 1 is, for example, an optical disc medium.

The optical disc apparatus 100 includes an optical head section 2, a preamplifier section 3, an AGC (Automatic Gain Controller) section 4, a waveform equalization section 5, an A/D conversion section 6, a PLL section 7, a PR equalization section 8, a maximum likelihood decoding section 9, a signal evaluation index detection section 10, and an optical disc controller section 15.

The signal evaluation index detection section 10 includes a 14-pattern detection section 101, a 12A-pattern detection section 104 and a 12B-pattern detection section 107 for respectively detecting patterns corresponding to Table 1 (14-patterns), Table 2 (12A-patterns) and Table 3 (12B-patterns); differential metric calculation sections 102, 105 and 108 for calculating a metric difference of each pattern; and memory sections 103, 06 and 109 for accumulating and storing a positional shift index of each pattern calculated by the differential metric calculation sections 102, 105 and 108.

The optical head section 2 converges laser light transmitted through an objective lens on a recording layer of the information recording medium 1, receives the reflected light, and generates an analog reproduction signal representing information recorded on the information recording medium 1. The numerical aperture of the objective lens is 0.7 to 0.9, and preferably is 0.85.

The laser light has a wavelength of 410 nm or shorter, preferably of 405 nm.

The preamplifier section 3 amplifies the analog reproduction signal at a prescribed gain and outputs the amplified analog reproduction signal to the AGC section 4.

The AGC section 4 amplifies the reproduction signal using a preset target gain, such that a reproduction signal output from the A/D conversion section 6 has a constant level, and outputs the reproduction signal to the waveform equalization section 5.

The waveform equalization section 5 has an LPF characteristic of shielding a high region of a reproduction signal and a filter characteristic of amplifying a prescribed frequency region of a reproduction signal, shapes the reproduction signal so as to have a desired characteristic and outputs the reproduction signal to the A/D conversion section 6.

The PLL circuit 7 generates a reproduction clock synchronized with the reproduction signal processed with waveform equalization and outputs the reproduction clock to the A/D conversion section 6.

The A/D conversion section 6 samples the reproduction signal in synchronization with the reproduction clock which is output from the PLL circuit 7, converts the analog reproduction signal to a digital reproduction signal, and outputs the digital reproduction signal to the PLL equalization section 8, the PLL section 7 and the AGC section 4.

The PLL equalization section 8 has, as a frequency characteristic of the reproduction system, a frequency characteristic which is set to be assumed by the maximum likelihood decoding section 9 (for example, PR(1,2,2,2,1) equalization characteristic), executes PR equalization processing of suppressing noise in a high region and adding an intentional inter-code interference on the reproduction signal, and outputs the resultant signal to the maximum likelihood decoding section 9.

The PR equalization section 8 may include an FIR (Finite Impulse Response) filter structure and adaptably control the tap coefficient using an LMS (The Least-Mean Square) algorithm (see “Tekioh Shingoshori Algorithm” (Adaptive Signal Processing Algorithm) published by Baifukan, Co., Ltd.).

The maximum likelihood decoding section 9 is, for example, a Viterbi decoder, and decodes the reproduction signal processed with PR equalization by the PR equalization section 8 using a maximum likelihood decoding method for estimating a matrix having the maximum likelihood based on the code rule intentionally added in accordance with the form of partial response, and outputs binary data.

The binary data is output to the optical disc controller 15 on a later stage as a demodulated binary signal and processed as prescribed. Thus, the information recorded on the information recording medium 1 is reproduced.

To the signal evaluation index detection section 10, the waveform-shaped digital reproduction signal output from the PR equalization section 8 and the binary signal output from the maximum likelihood decoding section 9.

The pattern detection sections 101, 104 and 107 compare the transition data sequences in Tables 1, 2 and 3 with the binary data. When the binary data matches the transition data sequences in Tables 1, 2 and 3, the pattern detection sections 101, 104 and 107 select a state transition matrix 1 having the maximum likelihood and a state transition matrix 2 having the second maximum likelihood based on Tables 1, 2 and 3.

Based on the selection results, the differential metric calculation sections 102, 104 and 108 calculate a metric, which is a distance between an ideal value of each state transition matrix (PR equalization ideal value; see Tables 1, 2 and 3) and the digital reproduction signal, and also calculate a difference between the metrics calculated on the two state transition matrices. Such a metric difference has a positive or a negative value, and therefore is subjected to absolute value processing.

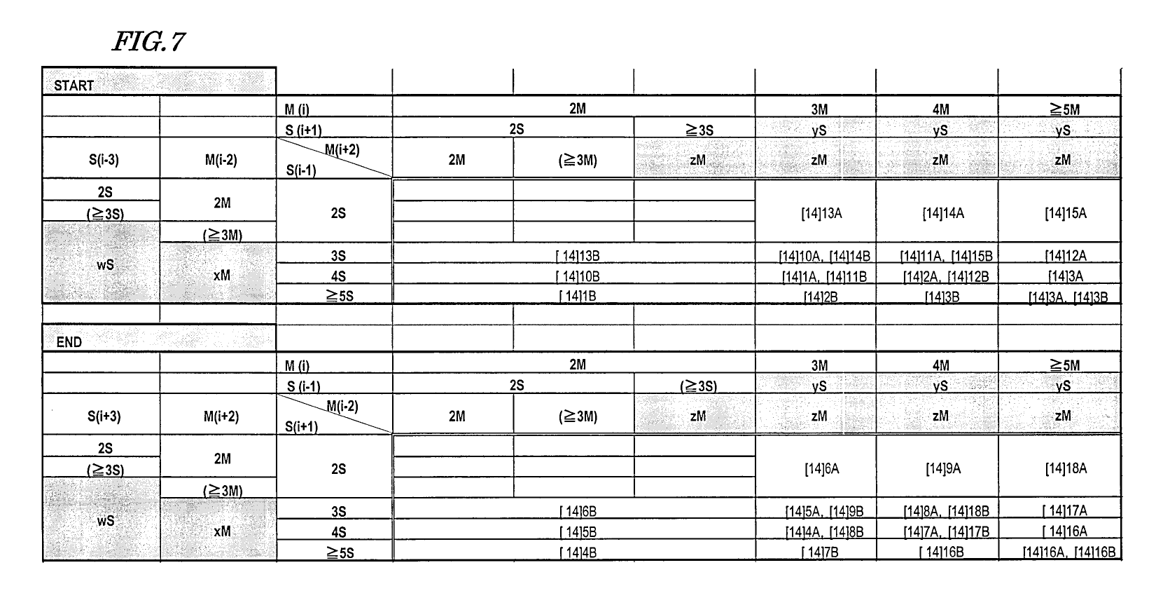

Based on the binary data, the pattern detection sections 101, 104 and 107 generate a pulse signal to be assigned to each of start edge/end edge patterns of the mark shown in FIGS. 7, 8 and 9, and output the pulse signal to the memory sections 103, 106 and 109.

Based on the pulse signal output from the pattern detection sections 101, 104 and 107, the memory sections 103, 106 and 109 accumulatively add the metric differences obtained by the differential metric calculation sections 102, 104 and 108 for each pattern shown in FIGS. 7, 8 and 9.

Now, the detailed pattern classification in FIGS. 7, 8 and 9 will be described in detail.

In FIGS. 7, 8 and 9, “M” represents a mark and “S” represents a space.

“i” represents time. For example, (2S(i−1), 3M(i), 4S(i+1) means a 2T space is present before a 3T mark as the reference and a 4T space is present after the 3T mark.

In FIGS. 7, 8 and 9, pattern numbers correspond to the pattern numbers in Tables 1, 2 and 3.

For example, referring to Table 1, data sequence [14]1A has a transition data sequence (0,0,0,0,1,1,1,0,0). Where 0 represents a space and 1 represents a mark, this transition data sequence has a pattern of (4T or longer space, 3T mark, 2T or longer space).

This pattern corresponds to the cell of (wS(i−3), xM(i−2), 4S(i−1), 3M(i), yS(i+1), zM(i+2)) in FIG. 7.

Each of w, x, y and z may be any numerical value representing the length which a mark or a space can have.

For example, in the case of the RLL(1,7) recording code, each of w, x, y and z may be any value of 2 to 9.

By the detailed pattern classification of the 14-detection patterns in FIG. 7, one edge shift of one space and one mark is classified. The “start” of a 14-detection pattern indicates an edge shift of a mark at time i and a space at time i−1. The “end” of a 14-detection pattern indicates an edge shift of a mark at time i and a space at time i+1.

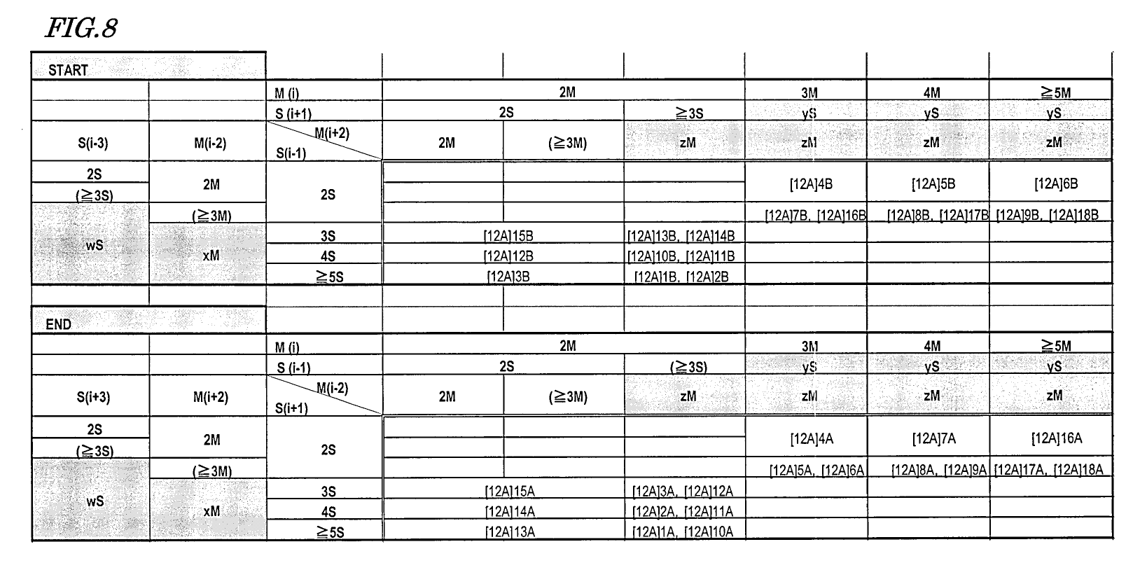

By the detailed pattern classification of the 12A-detection patterns in FIG. 8, a shift of a 2T mark or a 2T space in a 14-detection pattern shown in FIG. 7 is further classified by the mark or space at the immediately previous time or the immediately subsequent time.

In the “start” of the 12A-detection pattern, a shift of a 2T mark at time i sandwiched between a space at time i−1 and a space at time i+1 is classified by the length of the space at time i+1, or a shift of a 2T space at time i−1 sandwiched between a mark at time i and a mark at time i−2 is classified by the length of the mark at time i−2.

In the “end” of the 12A-detection pattern, a shift of a 2T mark at time i sandwiched between a space at time i−1 and a space at time i+1 is classified by the length of the space at time i−1, or a shift of a 2T space at time i+1 sandwiched between a mark at time i and a mark at time i+2 is classified by the length of the mark at time i+2.

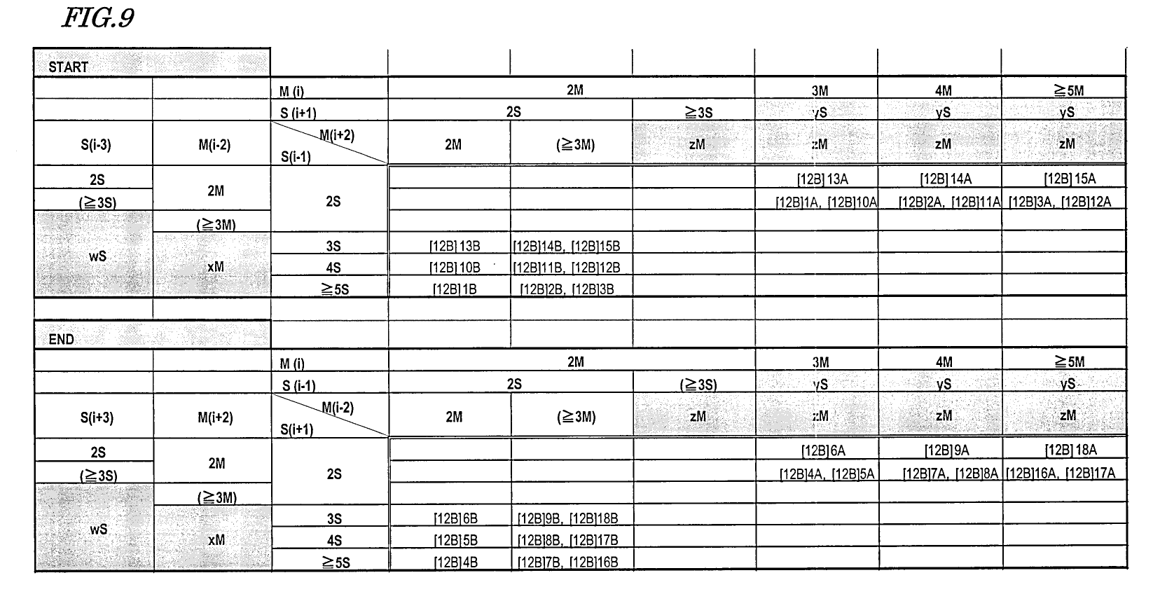

Finally, by the detailed pattern classification of the 12A-detection patterns in FIG. 9, a shift of continuous 2T mark and 2T space in a 12A-detection pattern shown in FIG. 8 is further classified by the mark or space at the further immediately previous time or the further immediately subsequent time. Namely, a shift of a 2T mark and a 2T space located in succession and sandwiched between one mark and one space is classified.

In the “start” of the 12B-detection pattern, a shift of a 2T mark at time i and a 2T space at time i+1 sandwiched between a mark at time i+2 and a space at time i−1 is classified by the length of the mark at time i+2, or a shift of a 2T mark at time i−2 and a 2T space at time i+1 sandwiched between a space at time i−3 and a mark at time i is classified by the length of the mark at time i−3.

In the “end” of the 12B-detection pattern, a shift of a 2T mark at time i and a 2T space at time i−1 sandwiched between a space at time i+1 and a mark at time i−2 is classified by the length of the mark at time i−2, or a shift of a 2T space at time i+1 and a 2T mark at time i+2 sandwiched between a mark at time i and a space at time i+3 is classified by the length of the mark at time i+3.

Hereinafter, a process for evaluating the recording quality will be described in detail.

In order to provide a signal evaluation index having a higher correlation with an error rate, an evaluation method considering all the patterns having a high likelihood of causing an error in the PR12221ML signal processing is required.

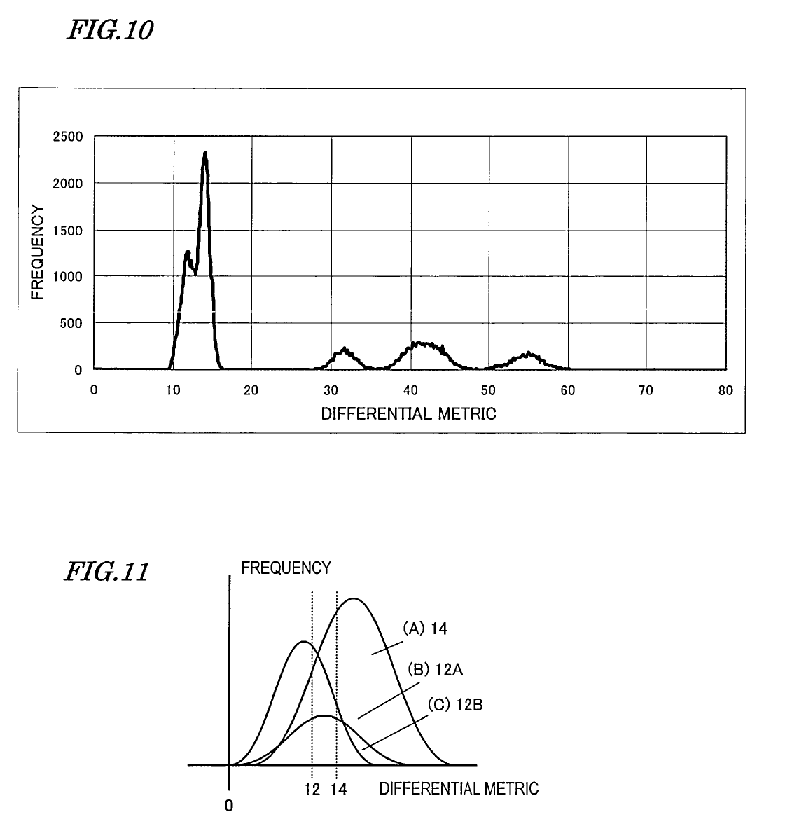

FIG. 10 shows a distribution of differential metrics in the PR12221ML signal processing.

The horizontal axis represents the square of the Euclidean distance, and the vertical axis represents the frequency.

FIG. 10 shows that as the square of the Euclidean distance of the distribution is smaller, the likelihood of causing an error in the PR12221ML signal processing is higher.

It is seen from this figure that the distribution has highly dense groups at the square of the Euclidean distance of 12 and 14, and in the range of the square of the Euclidean distance above 14, the differential metrics are present only at 30 or higher.

Namely, it is appreciated that in order to provide a signal index having a high correlation with the error rate, it is sufficient to pay attention to the groups at the square of the Euclidean distance of 12 and 14.

These groups correspond to the patterns shown in Table 1 and Tables 2 and 3.

The pattern detection sections 101, 104 and 107 identify these patterns.

Hereinafter, an operation of the differential metric calculation sections for calculating a metric difference from the identified patterns will be described in further detail.

A binary signal is generated from a reproduction signal reproduced from the disc by the PRML processing.

From the binary signal, any of the patterns of the transition data sequences in Table 1 is detected. Thus, the PR equalization ideal values of the state transition matrices 1 and 2 are determined.

For example, it is assumed that in Table 1, (0,0,0,0,X,1,1,0,0) is demodulated as a binary signal. In this case, as the state transition matrix 1 having the maximum likelihood, data sequence [14]1A(S0, S1, S2, S3, S5, S6) is selected. As the state transition matrix 2 having the second maximum likelihood, data sequence [14]1B(S0, S0, S1, S2, S9, S6) is selected.

The PR equalization ideal value for the state transition matrix 1 is (1,3,5,6,5).

The PR equalization ideal value for the state transition matrix 2 is (0,1,3,4,4).

Next, the square of the difference between the reproduction signal sequence and the PR equalization ideal value for the state transition matrix 1 is found and labeled Pa. Similarly, the square of the difference between the reproduction signal sequence and the PR equalization ideal value for the state transition matrix 2 is found and labeled Pb. The absolute value of the difference between Pa and Pb is the differential metric D₁₄=|Pa₁₄−Pb₁₄|.

This processing is performed by the differential metric calculation sections.

The calculation of Pa₁₄ is represented by expression (1). The calculation of Pb₁₄ is represented by expression (2).

In the expressions, aₖ is the PR equalization ideal value for the state transition matrix 1, bₖ is the PR equalization ideal value for the state transition matrix 2, and yₖ is the reproduction signal sequence.

Pa₁₄=Σₖ₌ₖ₋₅^{k}(yₖ−aₖ)² expression (1)

Pb₁₄=Σₖ₌ₖ₋₅^{k}(yₖ−bₖ)² expression (2)

D₁₄=|Pa₁₄−Pb₁₄| expression (3)

In FIG. 11, (A) represents an output frequency distribution of the differential metric calculation section 102.

Similarly, outputs from the differential metric calculation section 105 are represented by expressions (4) through (6), and outputs from the differential metric calculation section 108 are represented by expressions (7) through (9).

Pa_{12A}=Σₖ₌ₖ₋₇^{k}(yₖ−aₖ)² expression (4)

Pb_{12A}=Σₖ₌ₖ₋₇^{k}(yₖ−bₖ)² expression (5)

D_{12A}=|Pa_{12A}−Pb_{12A}| expression (6)

Pa_{12B}=Σₖ₌ₖ₋₉^{k}(yₖ−aₖ)² expression (7)

Pb_{12B}=Σₖ₌ₖ₋₉^{k}(yₖ−bₖ)² expression (8)

D_{12B}=|Pa_{12B}−Pb_{12B}| expression (9)

In FIG. 11, (B) represents an output frequency distribution of the differential metric calculation section 105, and (C) represents an output frequency distribution of the differential metric calculation section 108.

The distributions represented by (A), (B) and (C) in FIG. 11 are different in the frequency and the center position as well as in the number of error bits generated when the respective pattern causes an error.

In the patterns in Table 1 corresponding to the square of the Euclidean distance of 14, a 1-bit error is generated. In the patterns in Table 2 corresponding to the square of the Euclidean distance of 12, a 2-bit error is generated. In the patterns in Table 3 corresponding to the square of the Euclidean distance of 12, a 3- or greater bit error is generated.

Especially, the number of error bits of the patterns in Table 3 depends on the number of successive 2T marks/spaces. For example, in the case of a recording modulation code permitted to include 6 successive marks/spaces at the maximum, a 6-bit error is generated at the maximum.

Table 3 does not show 6-bit errors, but a pattern causing a 6-bit error may be obtained by expanding the pattern including successive 2T marks/spaces.

The pattern causing a 6-bit error is omitted in this embodiment.

Now, a method for classifying each detection pattern into a detailed pattern using the above-described differential metric calculation will be described.

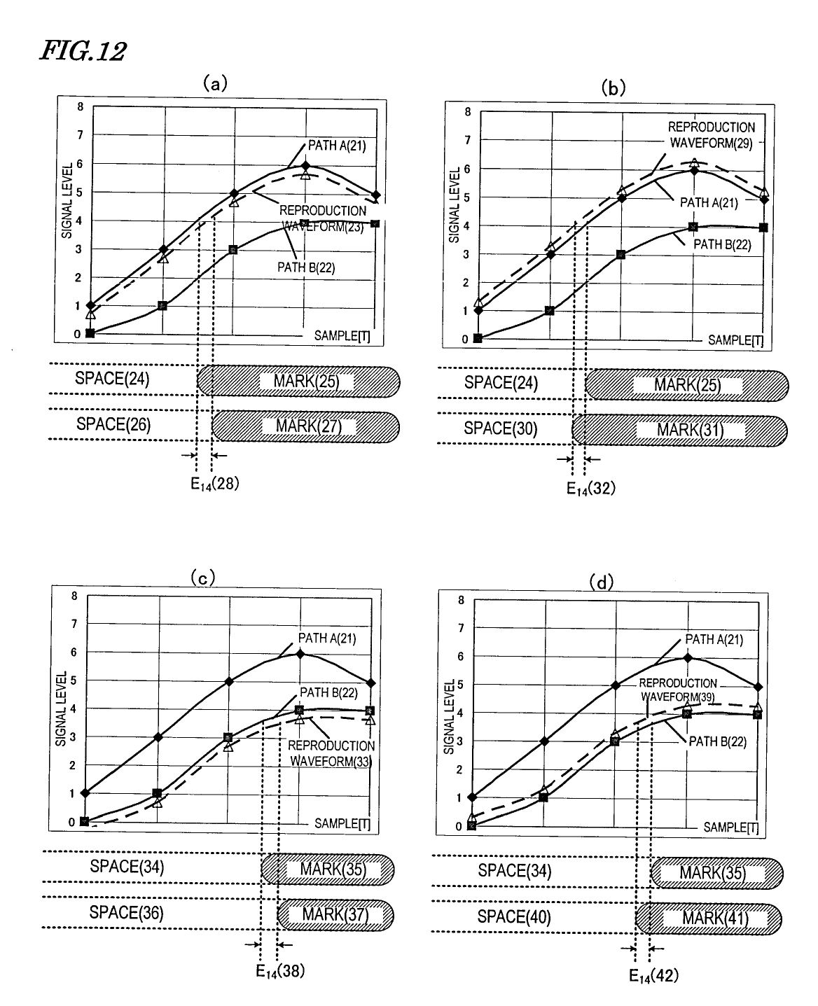

FIG. 12 shows the correlation between the reproduction waveform and the shift of the mark of a pattern shown in FIG. 4, which are provided as an example of the 14-pattern.

In FIG. 12(a), a path A21 is a state transition matrix having the maximum likelihood, and a path B22 is a state transition matrix having the second maximum likelihood.

A reproduction waveform 23 represented by the dashed line with white triangles represents a waveform of data, of the information recording medium, having a signal which is slightly closer to the path B22 with respect to the path A21 as the reference.

A space 24 and a mark 25 respectively represent the ideal positions of the space and the mark of path A21, which is the state transition matrix having the maximum likelihood. A space 26 and a mark 27 respectively represent the positions of the space and the mark at which the reproduction waveform 23 is obtained.

The signal levels of the reproduction waveform 23 at sampling points (yₖ₋₄, yₖ₋₃, yₖ₋₂, yₖ₋₁, yₖ) are (0.7,2.7,4.7,5.7,4.7).

At this point, the signal levels of the path A21 and the path B22 are aₖ=(1,3,5,6,5) and bₖ=(0,1,3,4,4).

From the above-mentioned signal levels and expressions (1) and (2), the distance Pa₁₄ between the reproduction waveform 23 and the path A21 and the distance Pb₁₄ between the reproduction waveform 23 and the path B22 are found as expressions (10) and (11).

Pa₁₄=(0.7−1)²+(2.7−3)²+(4.7−5)²+(5.7−6)²+(5.7−6)²=0.45 expression (10)

Pb₁₄=(0.7−0)²+(2.7−1)²+(4.7−3)²+(5.7−4)²+(5.7−4)²=9.65 expression (11)

From expression (3), the differential metric D₁₄ is found as expression (12).

D₁₄=|Pa₁₄−Pb₁₄|=|0.45−9.651|=9.2 expression (12)

Where the distance between the path A and the path B is Pstd₁₄, Pstd₁₄ is the value of Pb₁₄ at which Pa₁₄=0, i.e., Pstd₁₄ is 14.

A shift amount E₁₄ of the reproduction waveform from the path A21, which is the state transition matrix having the maximum likelihood, is obtained by expression (13) below.

E₁₄=D₁₄−Pstd₁₄=−9.2−14=−4.8 expression (13)

The absolute value of E₁₄ obtained from expression (13) is the shift amount, and the sign thereof is the shifting direction.

Now, the shifting direction represented by the sign of E₁₄ will be described.

Similarly to the above, in FIG. 12(b), a reproduction waveform 29 represented by the dashed line with white triangles has a signal level which is farther from the path B22 with respect to the path A21 as the reference.

Where the signal levels of the reproduction waveform 29 (yₖ₋₄, yₖ₋₃, yₖ₋₂, yₖ₋₁, yₖ) are (1.3,3.3,5.3,6.3,5.3), E₁₄(32)=4.8.

FIGS. 12(c) and (d) each show a case where the path B22 represents the state transition matrix having the maximum likelihood.

In FIG. 12(c), a reproduction waveform 33 represented by the dashed line with white triangles has a signal level which is farther from the path A21 with respect to the path B22 as the reference. In FIG. 12(d), a reproduction waveform 39 represented by the dashed line with white triangles has a signal level which is slightly closer to the path A21 with respect to the path B22 as the reference.

Where the signal levels of the reproduction waveforms 33 and 39 (yₖ₋₄, yₖ₋₃, yₖ₋₂, yₖ₋₁, yₖ) are (0,0.7,2.7,3.7,3.7) and (0.3,1.3,3.3,4.3,4.3), E₁₄(38)=4.2 and E₁₄(42)=−4.8.

From the above, when the reproduction waveform has a signal level which is closer to the state transition matrix having the second maximum likelihood with respect to the state transition matrix having the maximum likelihood, the sign of the E₁₄ value is negative. When the reproduction waveform has a signal level which is farther from the state transition matrix having the second maximum likelihood with respect to the state transition matrix having the maximum likelihood, the sign of the E₁₄ value is positive.

FIG. 13 shows the correlation between the reproduction waveform and the shift of the mark of a pattern shown in FIG. 5, which is provided as an example of the 12A-pattern.

In FIG. 13, a path A51 is a state transition matrix having the maximum likelihood, and a path B52 is a state transition matrix having the second maximum likelihood.

A reproduction waveform 53 represented by the dashed line with white triangles represents a waveform of data, of the information recording medium, having a signal which is slightly closer to the path B52 with respect to the path A51 as the reference.

Spaces 54 and 56 and a mark 55 respectively represent the ideal positions of the spaces and the mark of path A51, which is the state transition matrix having the maximum likelihood. Spaces 57 and 59 and a mark 58 respectively represent the positions of the spaces and the mark at which the reproduction waveform 53 is obtained.

The signal levels of the reproduction waveform 53 at sampling points (yₖ₋₇, yₖ₋₆, yₖ₋₅, yₖ₋₄, yₖ₋₃, yₖ₋₂, yₖ₋₁, yₖ) are (0.7,2.7,3.7,4,3.3,1.3,0.3).

At this point, the signal levels of the path A51 and the path B52 are aₖ=(1,3,4,4,3,1,0) and bₖ=(0,1,3,4,4,3,1).

From the above-mentioned signal levels and expressions (1) and (2), the distance Pa_{12A} between the reproduction waveform 53 and the path A51 and the distance Pb_{12A} between the reproduction waveform 53 and the path B52 are found as expressions (14) and (15).

Pa_{12A}=(0.7−1)²+(2.7−3)²+(3.7−4)²+(4−4)²+(3.3−3)²+(1.3−1)²+(0.3−0)²=0.54 expression (14)

Pb_{12A}=(0.7−0)²+(2.7−1)²+(3.7−3)²+(4−4)²+(3.3−4)²+(1.3−3)²+(0.3−1)²=7.74 expression (15)

From expression (3), the differential metric D_{12A} is found as expression (16).

D_{12A}=|Pa_{12A}−Pb_{12A}|=|0.54−7.74|=|7.2 expression (16)

Where the distance between the path A and the path B is Pstd_{12A}, Pstd_{12A} is the value of Pb_{12A} at which Pa_{12A}=0, i.e., Pstd_{12A} is 12.

A shift amount E_{12A} of the reproduction waveform from the path A51, which is the state transition matrix having the maximum likelihood, is obtained by expression (17) below.

E_{12A}=D_{12A}−Pstd_{12A}=7.2−12=−4.8 expression (17)

In the case of the 12A-pattern, as in the case of the 14-pattern, when the reproduction waveform has a signal level which is closer to the state transition matrix having the second maximum likelihood with respect to the state transition matrix having the maximum likelihood, the sign of the E_{12A} value is negative. When the reproduction waveform has a signal level which is farther from the state transition matrix having the second maximum likelihood with respect to the state transition matrix having the maximum likelihood, the sign of the E_{12A} value is positive.

In the example of FIG. 13, the mark 55 and the mark 58 are described as having the same length. The shift in the 12A-pattern is also applicable to a case where the ideal mark and the mark of the reproduction waveform have different lengths.

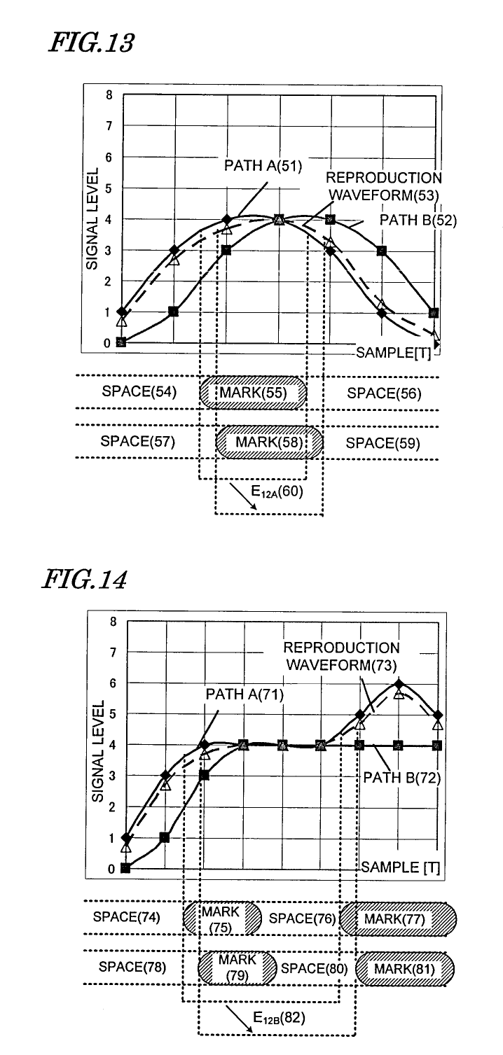

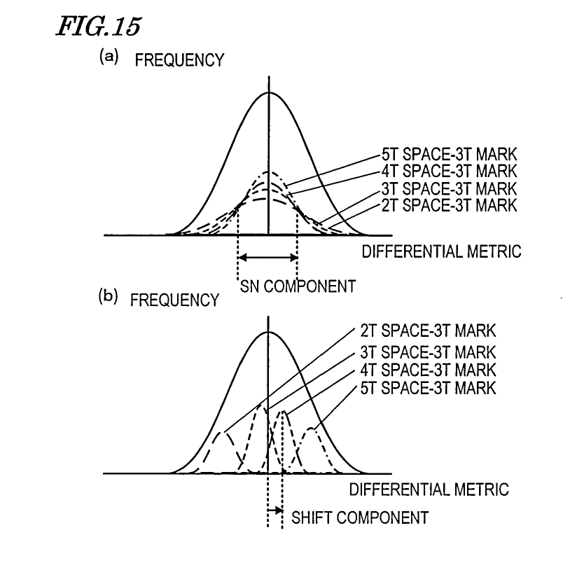

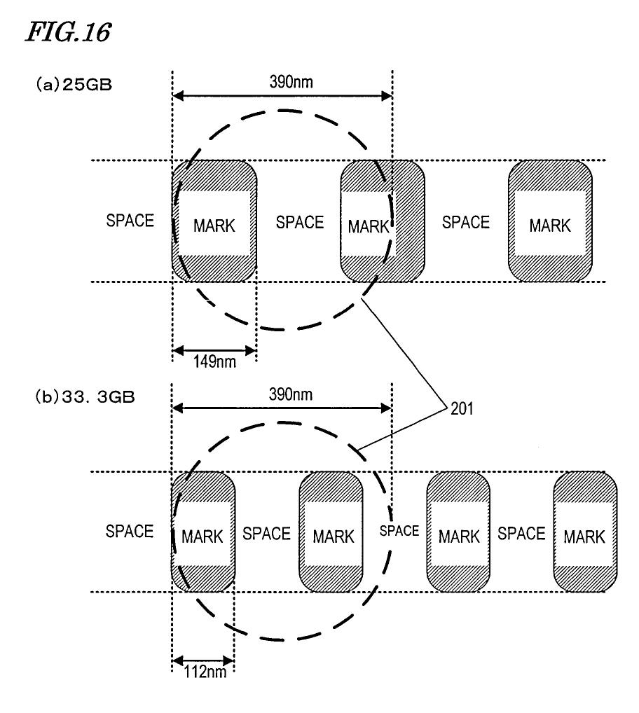

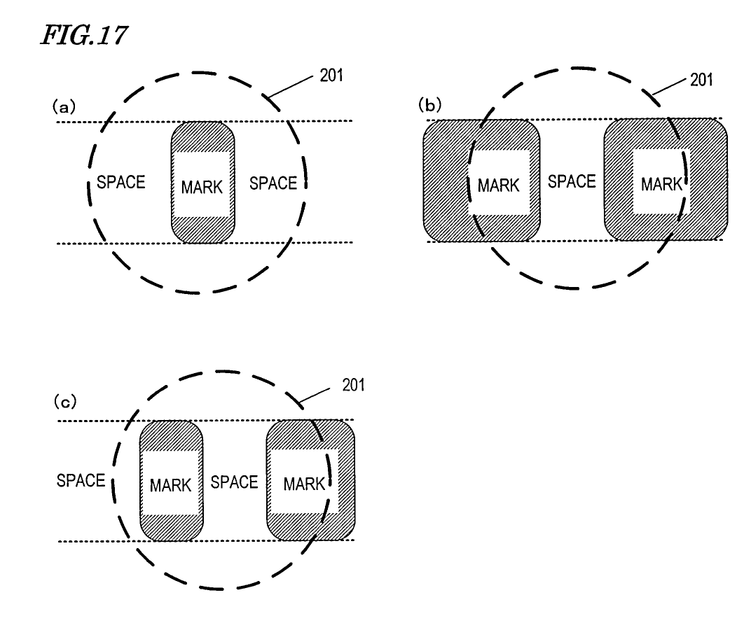

FIG. 14 shows the correlation between the reproduction waveform and the shift of the mark of a pattern shown in FIG. 6, which are provided as an example of the 12B-pattern.

In FIG. 14, a path A71 is a state transition matrix having the maximum likelihood, and a path B72 is a state transition matrix having the second maximum likelihood.

A reproduction waveform 73 represented by the dashed line with white triangles represents a waveform of data, of the information recording medium, having a signal which is slightly closer to the path B72 with respect to the path A71 as the reference.

Spaces 74 and 76 and marks 75 and 77 respectively represent the ideal positions of the spaces and the marks of path A71, which is in the state transition matrix having the maximum likelihood. Spaces 78 and 80 and marks 79 and 81 respectively represent the positions of the spaces and the marks at which the reproduction waveform 73 is obtained.

The signal levels of the reproduction waveform 73 at sampling points (yₖ₋₉, yₖ₋₈, yₖ₋₇, yₖ₋₆, yₖ₋₅, yₖ₋₄, yₖ₋₃, yₖ₋₂, yₖ₋₁, yₖ) are (0.7,2.7,3.7,4,4,4,4.7,5.7,4.7).

At this point, the signal levels of the path A71 and the path B72 are aₖ=(1,3,4,4,4,4,5,6,5) and bₖ=(0,1,3,4,4,4,4,4,4).

From the above-mentioned signal levels and expressions (1) and (2), the distance Pa_{12B} between the reproduction waveform 73 and the path A71 and the distance Pb_{12B} between the reproduction waveform 73 and the path B72 are found as expressions (18) and (19).

Pa_{12b}=(0.7−1)²+(2.7−3)²+(3.7−4)²+(4−4)²+(4−4)²+(4−4)²+(4.7−5)²+(5.7−6)²+(4.7−5)²=0.54 expression (18)

Pb_{12b}=(0.7−0)²+(2.7−1)²+(3.7−3)²+(4−4)²+(4−4)²+(4−4)²+(4.7−4)²+(5.7−4)²+(47−4)²=7.74 expression (19)

From expression (3), the differential metric D_{12A} is found as expression (20).

D_{12B}=|Pa_{12B}−Pb_{12B}|=|0.54−7.74|=7.2 expression (20)

Where the distance between the path A and the path B is Pst_{12B} , Pst_{12B} is the value of Pb_{12B} at which Pa_{12B}=0, i.e., Pst_{12B} is 12.

A shift amount E_{12B} of the reproduction waveform from the path A71, which is the state transition matrix having the maximum likelihood, is obtained by expression (21) below.

E_{12B}=D_{12B}−Pstd_{12B}=7.2−12=−4.8 expression (21)

In the case of the 12B-pattern, as in the case of the 14-pattern, when the reproduction waveform has a signal level which is closer to the state transition matrix having the second maximum likelihood with respect to the state transition matrix having the maximum likelihood, the sign of the E_{12B} value is negative. When the reproduction waveform has a signal level which is farther from the state transition matrix having the second maximum likelihood with respect to the state transition matrix having the maximum likelihood, the sign of the E_{12B} value is positive.

In the example of FIG. 14, the mark 75 and the space 76 are described as having the same lengths as the mark 79 and the space 80. The shift in the 12B-pattern is also applicable to a case where the ideal mark or space and the mark or space of the reproduction waveform have different lengths.

As described above, according to Embodiment 1, it is made possible to calculate, using the PR12221ML signal processing, a differential metric of a pattern by which the square of the Euclidean distance between two ideal signals, i.e., the state transition matrix having the maximum likelihood and the state transition matrix having the second maximum likelihood, is 12 or 14. Thus, it is made possible to represent how each edge is shifted in a detection signal including a plurality of edges, with an index correlating with the error rate. As a result, the recording and reproduction quality of a high density information recording medium can be evaluated.

Using such an evaluation index, it is made possible to feedback the results of the recording quality evaluation to a reproduction compensation section or a recording compensation section at the time of information recording to or reproduction from a high density information recording medium. Thus, the reproduction errors can be reduced, and high quality recording with few errors can be performed.

The preamplifier section 3, the AGC section 4 and the waveform equalization section 5 shown in FIG. 1 in this embodiment may be structured as one analog integrated circuit (LSI).

The preamplifier section 3, the AGC section 4, the waveform equalization section 5, the A/D conversion section 6, the PLL section 7, the PR equalization section 8, the maximum likelihood decoding section 9, the signal evaluation index detection section 10 and the optical disc controller section 15 may be structured as one integrated circuit (LSI) having both analog and digital elements mounted thereon.

The above-described optical disc apparatus 100 is a reproduction apparatus, but may be a recording and reproduction apparatus.

In such a case, a circuit for recording is added, but the description thereof will be omitted in this embodiment.

These examples of the structure of the optical disc apparatus do not limit the present invention, and other structures are usable.

In the above embodiment, maximum likelihood decoding is performed using a state transition rule defined by a code having a shortest mark length of 2 and the equalization method PR(1,2,2,2,2,1), but the present invention is not limited to this.

For example, the present invention is also applicable to a case where a code having a shortest mark length of 2 or 3 and the equalization method PR(C0, C1, C1, C0) are used, or to a case where a code having a shortest mark length of 3 and the equalization method PR(C0, C1, C2, C1, C0) are used. C0, C1 and C2 may each be any positive numeral.

In the above embodiment, only the marks and spaces having the shortest length are classified in detail, but the present invention is not limited to this.

For example, the present invention is applicable to marks or spaces having the second shortest length, or marks or spaces which are shorter than a prescribed length, instead of marks having the shortest length.

### INDUSTRIAL APPLICABILITY

The present invention is especially useful in the technical field of performing signal processing using a maximum likelihood method.

What is claimed is:

1. An information reproduction apparatus, usable for an information recording medium having a data sequence including a mark and a space located alternately, for generating a binary signal from a signal obtained by reproducing the data sequence using a PRML signal processing method and evaluating a likelihood of the binary signal, the information reproduction apparatus comprising:
a differential metric calculation section for calculating, from the binary signal, a differential metric which is a difference of a reproduction signal from a first state transition matrix having a maximum likelihood and a second state transition matrix having a second maximum likelihood; and
a pattern detection section for classifying the differential metric to any of a plurality of data patterns each including at least one mark and at least one space;
wherein the data pattern classification to any of the plurality of data patterns is performed using a combination of a length of a first mark included in the data sequence and a length of a first space adjacently located immediately previous or immediately subsequent to the first mark, and is further performed using a length of a second mark which is not adjacent to the first mark and located adjacent to the first space; and thus a reproduction signal quality of the information recording medium is evaluated.

2. The information reproduction apparatus of claim 1, wherein the classification using the length of the second mark is performed only when the length of the first mark is equal to or shorter than a prescribed length.

3. The information reproduction apparatus of claim 1, wherein the data pattern classification is further performed using a length of a second space which is located adjacent to neither the first mark nor the first space and located adjacent to the second mark.

4. The information reproduction apparatus of claim 3, wherein the classification using the length of the second space is performed only when the length of the second mark is equal to or shorter than the prescribed length.

5. An information reproduction apparatus, usable for an information recording medium having a data sequence including a mark and a space located alternately, for generating a binary signal from a signal obtained by reproducing the data sequence using a PRML signal processing method and evaluating a likelihood of the binary signal, the information reproduction apparatus comprising:
a differential metric calculation section for calculating, from the binary signal, a differential metric which is a difference of a reproduction signal from a first state transition matrix having a maximum likelihood and a second state transition matrix having a second maximum likelihood; and
a pattern detection section for classifying the differential metric to any of a plurality of data patterns each including at least one mark and at least one space;
wherein the data pattern classification to any of a plurality of data patterns is performed using a combination of a length of a first mark included in the data sequence and a length of a first space adjacently located immediately previous or immediately subsequent to the first mark, and is further performed using a length of a third space which is not adjacent to the first space and located adjacent to the first mark; and thus a reproduction signal quality of the information recording medium is evaluated.

6. The information reproduction apparatus of claim 5, wherein the classification using the length of the third space is performed only when the length of the first mark is equal to or shorter than a prescribed length.

7. The information reproduction apparatus of claim 5, wherein the data pattern classification is further performed using a length of a third space which is located adjacent to neither the first mark nor the first space and located adjacent to the third space.

8. The information reproduction apparatus of claim 7, wherein the classification using the length of the third mark is performed only when the length of the third space is equal to or shorter than the prescribed length.

9. The information reproduction apparatus of claim 2, wherein the prescribed length is the shortest mark length in the data sequence.

10. The information reproduction apparatus of claim 6, wherein the prescribed length is the shortest mark length in the data sequence.
